(19) United States
(12) Patent Application Publication
(10) Pub. No.: US 2025/0308777 A1
(43) Pub. Date: Oct. 2, 2025

(54) MULTILAYER CERAMIC ELECTRONIC COMPONENT AND METHOD FOR MANUFACTURING SAME, AS WELL AS CIRCUIT MODULE, AND ELECTRONIC DEVICE

(71) Applicant: TAIYO YUDEN CO., LTD., Tokyo (JP)

(72) Inventor: Wakaaki MURAI, Takasaki-shi (JP)

(21) Appl. No.: 19/089,439

(22) Filed: Mar. 25, 2025

(30) Foreign Application Priority Data
Mar. 29, 2024 (JP) 2024-056491

(51) Int. Cl. H01G 4/008; H01G 4/12; H01G 4/232; H01G 4/30

(52) U.S. Cl. CPC H01G 4/0085; H01G 4/30; H01G 4/1227; H01G 4/2325

(57) ABSTRACT

A multilayer ceramic electronic component includes: an element body having multiple dielectric layers laminated along a first axis and multiple internal electrode layers respectively placed along the first axis between the adjacent pairs of the dielectric layers; and a pair of external electrodes provided on the surface of the element body and electrically connected to the internal electrode layers; wherein, the dielectric layers contain a compound expressed by the general formula ABO_{3-α} (0≤α≤1) and having a perovskite structure; the internal electrode layers contain a first phase containing nickel and copper, as well as a co-existent material, and have, at the interfaces between the first phase and the co-existent material, first segregation parts where copper has segregated; the concentration of copper in the first segregation parts is higher than the concentration of copper in the first phase; and the external electrodes contain nickel.

### CROSS-REFERENCE TO RELATED APPLICATIONS

The present application claims priority to Japanese Patent Application No. 2024-056491, filed Mar. 29, 2024, the disclosure of which is incorporated herein by reference in its entirety including any and all particular combinations of the features disclosed therein.

### BACKGROUND

### Field of the Invention

The present disclosure relates to a multilayer ceramic electronic component and a method for manufacturing the same, as well as a circuit module, and an electronic device.

### Description of the Related Art

Multilayer ceramic electronic components such as multilayer ceramic capacitors (MLCCs) have been developed for installation in smartphones, personal computers, and various other electronic devices. The multilayer ceramic electronic components continue to see rising demands for size reduction and capacity increase as electronic devices become increasingly multi-functional/high in performance as well as large in battery capacity.

As for the capacity increase of ceramic electronic components, material compositions that increase the dielectric constants of dielectric materials used are being studied, while thickness reduction of dielectric layers and other measures are being taken. Meanwhile, making internal electrode layers thinner and thereby increasing the number of laminated layers is also an effective means. However, making the internal electrode layers thinner may present a problem of over-sintering, and consequently a lower continuity rate, of the internal electrode layers because the dielectric layers and internal electrode layers have different densification temperature ranges in the sintering stage. In such a case, connectivity between the internal electrode layers and external electrodes will drop, which in turn may prevent the desired properties from being achieved.

This has led to, for example, Patent Literature 1 that discloses a multilayer-type capacitor, comprising: a main body that comprises dielectric layers and internal electrodes placed alternately therewith; and external electrodes placed on the main body and connected to the internal electrodes; wherein, the internal electrodes comprise Ni crystal particles, a ceramic distributed inside the Ni crystal particles, first coating layers surrounding the Ni crystal particles, and second coating layers surrounding the ceramic; and the multilayer-type capacitor allows the internal electrodes to be made thin but subject to little thickness variation while also demonstrating excellent connection property because their outward growth is inhibited and also because the coated ceramic present inside the Ni crystal particles inhibits the Ni from moving and thereby inhibits spheroidization of the internal electrodes as well as disconnection of the internal electrodes.

Also, Patent Literature 2 discloses a ceramic electronic component, comprising: a multilayer chip formed in such a way that multiple dielectric layers whose main component is a ceramic are alternately laminated with multiple internal electrode layers whose main component is Ni, that it has a roughly rectangular parallelepiped shape, and that the multiple internal electrode layers are alternately exposed to two opposing end faces of the roughly rectangular parallelepiped shape; and external electrodes which are provided on the two end faces and whose main component is Ni; wherein, the multiple internal electrode layers contain an additive metal element other than Ni, as well as a co-existent material, and the concentration of the additive metal element is higher in the internal electrode layers than in the external electrodes; and the ceramic electronic component can maintain connectivity between the internal electrode layers and external electrodes.

### BACKGROUND ART LITERATURES

Patent Literature 1: Japanese Patent Laid-open No. 2019-176117
Patent Literature 2: Japanese Patent Laid-open No. 2023-136776

### SUMMARY

With the conventional multilayer ceramic electronic components, a co-existent material is left in the internal electrode layers in order to delay the sintering of the internal electrode layers, so that an over-sintering of the internal electrode layers is inhibited even when they are sintered at the sintering temperature of the dielectric layers. This can inhibit the continuity rate of the internal electrode layers from dropping, thereby preventing a drop in the connectivity between the internal electrode layers and external electrodes. However, the co-existent material remaining in the internal electrode layers presents a problem of an increased resistance of the internal electrode layers and consequent drop in reliability.

An object of the present disclosure is to provide a multilayer ceramic electronic component, and a method for manufacturing multilayer ceramic electronic component, that can achieve an improved connectivity between the internal electrode layers and external electrodes along with an improved reliability.

An embodiment of the present disclosure is a multilayer ceramic electronic component, comprising: an element body having multiple dielectric layers laminated along a first axis and multiple internal electrode layers respectively placed along the first axis between the adjacent pairs of the dielectric layers; and a pair of external electrodes provided on the surface of the element body and electrically connected to the internal electrode layers; wherein, the dielectric layers contain a compound expressed by the general formula ABO_{3-α} (0≤α≤1) and having a perovskite structure wherein A and B represent an A-site element and a B-site element, respectively, of the perovskite structure; the internal electrode layers contain a first phase containing nickel and copper, as well as a co-existent material, and have, at the interfaces between the first phase and particles of the co-existent material, first segregation parts where copper has segregated; the concentration of copper in the first segregation parts is higher than the concentration of copper in the first phase; and the external electrodes contain nickel.

According to the present disclosure, a multilayer ceramic electronic component, and a method for manufacturing multilayer ceramic electronic component, that can achieve an improved connectivity between the internal electrode layers and external electrodes along with an improved reliability, can be provided. For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 is a perspective partial cross-sectional view illustrating the multilayer ceramic capacitor pertaining to an embodiment of the present disclosure.

FIG. 2 is a cross-sectional view illustrating a section cut along line A-A in FIG. 1.

FIG. 3 is a cross-sectional view illustrating a section cut along line B-B in FIG. 1.

FIG. 4 is an enlarged partial cross-sectional view of the dielectric layers, internal electrode layers, and second segregation parts of the element body 10 inside region D in FIG. 3.

FIG. 5 is an enlarged partial cross-sectional view of dielectric layers and an internal electrode layer.

FIG. 6A is a drawing explaining a method for measuring the concentration of copper in a first segregation part.

FIG. 6B is an enlarged view of region A in FIG. 5 and a drawing explaining the measuring direction for measuring the concentration of copper in a first segregation part.

FIG. 7A is a drawing explaining a method for measuring the concentration of copper in a second segregation part.

FIG. 7B is an enlarged view of region B in FIG. 5 and a drawing explaining the measuring direction for measuring the concentration of copper in a second segregation part.

FIG. 8 is a flow chart of a method for manufacturing the multilayer ceramic capacitor pertaining to an embodiment of the present disclosure.

FIG. 9A is a drawing illustrating the internal electrode layer pattern-forming step in the method for manufacturing the multilayer ceramic capacitor pertaining to an embodiment of the present disclosure.

FIG. 9B is a drawing illustrating the laminated body-forming step in the method for manufacturing the multilayer ceramic capacitor pertaining to an embodiment of the present disclosure.

FIG. 10 is a graph showing the result of STEM element analysis in Example 1. The vertical axis represents Cu concentration (at %) or Ba concentration (at %), while the horizontal axis represents measured distance (nm).

FIG. 11A is a traced drawing of a BF-STEM image taken on the XZ-plane of the measurement sample 2 in Comparative Example 1.

FIG. 11B is a traced drawing of a BF-STEM image taken on the XZ-plane of the measurement sample 2 in Example 1.

FIG. 11C is a traced drawing of a BF-STEM image taken on the XZ-plane of the measurement sample 2 in Comparative Example 4.

FIG. 12A is a graph showing the frequency of the total area of the co-existent material in three layers, obtained from a BF-STEM image of internal electrode layers taken on the XZ-plane of the measurement sample 2 in Comparative Example 1.

FIG. 12B is a graph showing the frequency of the total area of the co-existent material in three layers, obtained from a BF-STEM image of internal electrode layers taken on the XZ-plane of the measurement sample 2 in Example 1.

FIG. 12C is a graph showing the frequency of the total area of the co-existent material in three layers, obtained from a BF-STEM image of internal electrode layers taken on the XZ-plane of the measurement sample 2 in Comparative Example 4.

FIG. 13 is a graph showing the co-existent material area ratios (%) in three layers, obtained from BF-STEM images of internal electrode layers taken on the XZ-planes of the measurement samples 2 in Example 1 and Comparative Examples 1 and 4

FIG. 14A is a graph showing the result, in Example 1, of the atomic percent of Cu (at %) based on that of Ti being 100 at % according to the semiquantitative analysis method using a glass standard reference material. The vertical axis represents the atomic percent of Cu (at %) based on that of Ti being 100 at %, while the horizontal axis represents the distance from an internal electrode layer (μm).

FIG. 14B is a graph showing the result, in Comparative Example 4, of the atomic percent of Au (at %) based on that of Ti being 100 at % according to the semiquantitative analysis using a glass standard reference material. The vertical axis represents the atomic percent of Au (at %) based on Ti being 100 at %, while the horizontal axis represents the distance from an internal electrode layer (μm).

### DESCRIPTION OF THE SYMBOLS

100 Multilayer ceramic capacitor
10 Element body
10a First side face
10b Second side face
10c Third side face
10d Fourth side face
11 Dielectric layer
12 Internal electrode layer
12a First internal electrode layer
12b Second internal electrode layer
13 Cover layer
14 Capacitive part
15a First end margin
15b Second end margin
16 Side margin
17 First phase
18 Co-existent material
20 External electrode
20a First external electrode
20b Second external electrode
40 Second segregation part
50 First segregation part
C Region
D Region
S1 Raw material powder preparation step
S2 Slurry preparation step
S3 Coating step
S4 Internal electrode layer pattern-forming step
S5 Laminated body-forming step
S6 Singulation step
S7 External electrode precursor-forming step
S8 First heating step
S9 Second heating step
S10 Reoxidation treatment step
S11 Plating treatment step
71 Dielectric layer precursor sheet
72 Internal electrode layer pattern
72a First internal electrode layer pattern
72b Second internal electrode layer pattern
73 Dielectric pattern
d(A) End part at which measurement is started
d(B) Measured distance until Cu concentration drops to baseline B
d(C) End part at which measurement is terminated
c(A) Peak Cu concentration
d(D) End part at which measurement is started
d(E) Measured distance until Cu concentration drops to baseline E
d(F) End part at which measurement is terminated
c(B) Peak Cu concentration

### DETAILED DESCRIPTION OF EMBODIMENTS

An embodiment of the present disclosure is explained in detail below. It should be noted that the embodiment is not limited by the following descriptions and can be modified as deemed appropriate to the extent that doing so does not deviate from the key points of the present disclosure. Unless otherwise stipulated, the “to” indicating a range of numerical values in this Specification carries a meaning that the numerical values shown before and after it are included in the range as the lower-limit value and the upper-limit value.

Additionally, in this Specification and the drawings attached hereto, those components that effectively have the same functional configuration s are sometimes denoted by the same symbols to omit redundant explanations. Also, in this Specification and the drawings attached hereto, the quantity, position, size, shape, etc., of each component are not limited to those in the embodiment of the present disclosure and may be changed to any desired quantity, position, size, shape, etc., in embodying the present disclosure. Additionally, the drawings show, as deemed appropriate, the X-axis, Y-axis, and Z-axis that are crossing with one another at right angles. The X-axis, Y-axis, and Z-axis specify a fixed coordinate system that is fixed for the multilayer ceramic capacitor representing an example of multilayer ceramic electronic component. When the outer shape of the multilayer ceramic capacitor representing an example of multilayer ceramic electronic component is a rough rectangular parallelepiped, the X-axis, Y-axis, and Z-axis can correspond to the length, width, and height of the multilayer ceramic capacitor.

### [Multilayer Ceramic Electronic Component]

The multilayer ceramic electronic component in this embodiment has: an element body having multiple dielectric layers laminated along a first axis and multiple internal electrode layers respectively placed along the first axis between the adjacent pairs of the dielectric layers; and a pair of external electrodes provided on the surface of the element body and electrically connected to the internal electrode layers. The multilayer ceramic electronic component in this embodiment may also have other layers or members if necessary.

### (1) Structure of Multilayer Ceramic Electronic Component

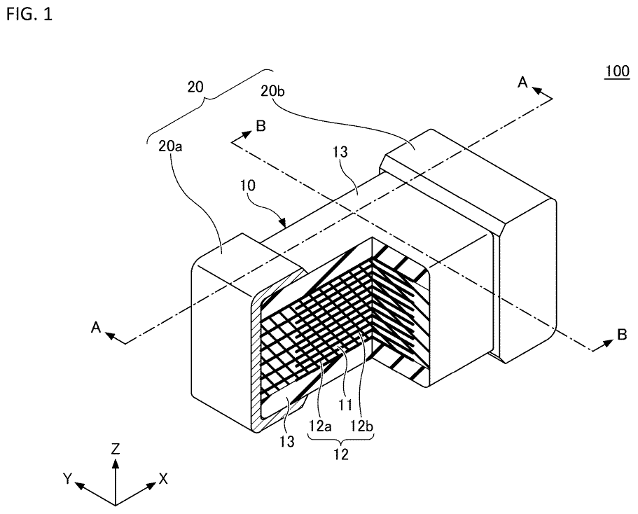

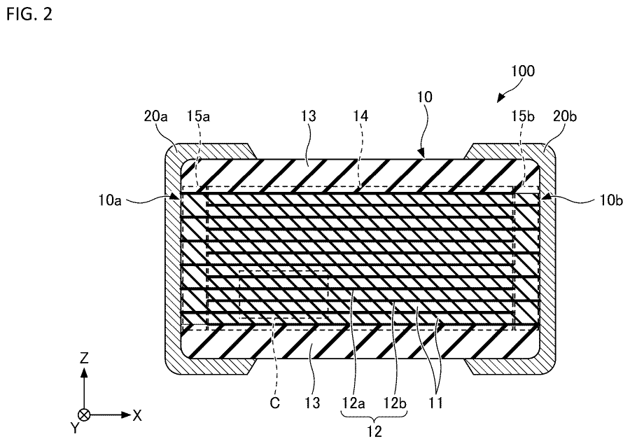

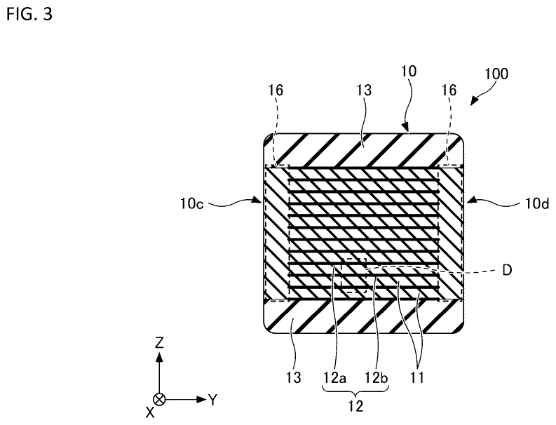

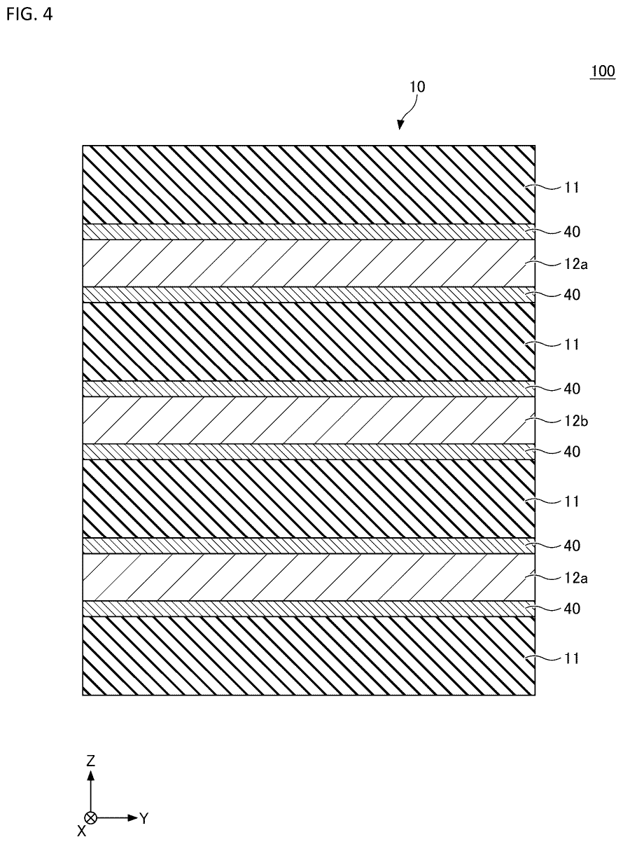

FIG. 1 is a perspective partial cross-sectional view illustrating the multilayer ceramic capacitor 100 pertaining to an embodiment of the present disclosure. FIGS. 2 and 3 are cross-sectional views illustrating the multilayer ceramic capacitor. FIG. 2 is a cross-sectional view illustrating a section cut along line A-A in FIG. 1. FIG. 3 is a cross-sectional view illustrating a section cut along line B-B in FIG. 1. FIG. 4 is an enlarged partial cross-sectional view of the dielectric layers, internal electrode layers, and second segregation parts of the element body 10 inside region D in FIG. 3.

The multilayer ceramic capacitor 100 comprises an element body 10 having a roughly rectangular parallelepiped shape, as well as a first external electrode 20a and a second external electrode 20b as a pair of external electrodes 20.

In the element body 10, the two opposing faces on its surface are referred to as the “upper face” and “lower face,” while the four faces that connect the upper face and lower face are referred to as the “side faces.” Normally the lower face represents, but is not limited to, the face on the board side when the multilayer ceramic capacitor 100 is mounted on a circuit board. In the examples shown in FIGS. 1 to 3, the element body 10 is such that the first external electrode 20a and second external electrode 20b are provided on a first side face 10a and a second side face 10b, respectively, which correspond to two opposing side faces. The first external electrode 20a extends from the first side face 10a onto the four adjoining faces. The second external electrode 20b extends from the second side face 10b onto the four adjoining faces. It should be noted, however, that the first external electrode 20a and second external electrode 20b are separated from each other. The external electrodes are not limited to being on the two opposing side faces, so long as they are provided on the surface of the element body 10.

The lamination direction in which dielectric layers 11 and internal electrode layers 12 are laminated is the first axis, and in FIGS. 1 to 3, the first axis representing the lamination direction of the dielectric layers 11 and internal electrode layers 12 corresponds to the Z-axis, being the direction in which the internal electrode layers are facing each other.

The axis orthogonal to the first axis representing the lamination direction is the second axis. In FIGS. 1 to 3, the second axis, which is the axis orthogonal to the first axis representing the lamination direction, corresponds to the X-axis. The second axis runs along the length direction of the element body 10 and is the axis running along the direction in which the first side face 10a and second side face 10b of the element body 10 are facing each other, as well as the direction in which the first external electrode 20a and second external electrode 20b are facing each other.

The axis orthogonal to the first axis representing the lamination direction and also orthogonal to the second axis, is the third axis. The third axis is the axis that runs along the width of the internal electrode layers 12. In FIGS. 1 to 3, the third axis, which is orthogonal to the first axis representing the lamination direction and also orthogonal to the second axis, corresponds to the Y-axis and is the axis running along the direction in which a third side face 10c and a fourth side face 10d being the two side faces, besides the first side face 10a and second side face 10b, of the four side faces of the element body 10, are facing each other (refer to FIG. 3). The X-axis, Y-axis, and Z-axis are mutually orthogonal.

The lamination direction is not limited to the Z-axis direction and may be any arbitrary direction. Accordingly, the first axis representing the lamination direction may be, for example, the X-axis corresponding to the X-direction or Y-axis corresponding to the Y-direction.

In the present application for patent, a drawing illustrating a specific embodiment may be used to explain general embodiments encompassing the specific embodiment; however, any subject matter explained based on the coordinate axis system used in an embodiment is applied correspondingly in general embodiments as being based on a general coordinate system in which the lamination direction is the first axis. For example, what are used in FIGS. 1 to 3 representing a specific embodiment where the lamination direction corresponds to the Z-direction, and are explained as the X-axis, Y-axis, and Z-axis therein, can be applied correspondingly as the second axis, third axis, and first axis, respectively, in general embodiments.

The element body 10 is constituted in such a way that dielectric layers 11 containing a ceramic material that functions as a dielectric, and internal electrode layers 12, are laminated together alternately. The internal electrode layers 12 include multiple first internal electrode layers 12a and multiple second internal electrode layers 12b. The first internal electrode layers 12a and second internal electrode layers 12b are laminated together alternately. The edges of the first internal electrode layers 12a are extracted to the surface on which the first external electrode 20a is provided, or specifically first side face 10a in the examples of FIGS. 1 to 3, of the element body 10. The edges of the second internal electrode layers 12b are extracted to the surface on which the second external electrode 20b is provided, or specifically second side face 10b in the examples of FIGS. 1 to 3, of the element body 10. This means that the first internal electrode layers 12a and second internal electrode layers 12b are electrically connected to the first external electrode 20a and second external electrode 20b alternately. As a result, the multilayer ceramic capacitor 100 is constituted as a laminate of capacitor units.

Also, the laminated body comprising the dielectric layers 11 and internal electrode layers 12 is such that internal electrode layers 12 are placed as the outermost layers in the lamination direction, and the outer side faces in the lamination direction of the laminated body, or specifically upper face and lower face in the examples of FIGS. 1 to 3, are covered with cover layers 13. The cover layers 13 have a ceramic material as the main component. For example, the cover layers 13 may be identical to, or different from, the dielectric layers 11 in terms of compositional makeup. It should be noted that the constitution is not limited to the one shown in FIGS. 1 to 3 so long as the first internal electrode layers 12a and second internal electrode layers 12b are exposed to different regions on the surface of the laminated body and electrically connected to different external electrodes. The “different regions on the surface of the laminated body” may be surface regions that are on opposing faces of the laminated body, respectively, or surface regions that are on adjoining faces of the laminated body, respectively, or surface regions that are different from each other on the same face of the laminated body. So long as they are separated from each other, the different external electrodes may extend onto other faces from the faces where the first internal electrode layers 12a and second internal electrode layers 12b are exposed to the surface regions of the laminated body, respectively.

Preferably the element body 10 has, at the interfaces between the dielectric layers 11 and internal electrode layers 12, second segregation parts 40 where copper has segregated (refer to FIG. 4), the details of which are described later. In FIGS. 1 to 3, the second segregation parts 40 are not shown.

The size of the multilayer ceramic capacitor 100 is not specifically limited, but it may be, for example, 0.25 mm in length, 0.125 mm in width, and 0.125 mm in height, or 0.4 mm in length, 0.2 mm in width, and 0.2 mm in height, or 0.6 mm in length, 0.3 mm in width, and 0.3 mm in height, or 1.0 mm in length, 0.5 mm in width, and 0.5 mm in height, or 3.2 mm in length, 1.6 mm in width, and 1.6 mm in height, or 4.5 mm in length, 3.2 mm in width, and 2.5 mm in height. It should be noted, however, that the sizes of the multilayer ceramic capacitor 100 listed above are only examples and the multilayer ceramic capacitor 100 is not limited to the aforementioned sizes. The size of the multilayer ceramic capacitor 100 may be one, for example, that satisfies the relationship of “length>width≥height,” or “width>length≥height,” or “height>length≥width,” or “height>width≥length.” It should be noted that, for example, the length represents the size in X-axis direction, width represents the size in Y-axis direction, and height represents the size in Z-axis direction.

As explained above, the multilayer ceramic capacitor 100 in this embodiment has multiple dielectric layers 11 laminated along the Z-axis being the first axis, multiple internal electrode layers 12 respectively placed along the first axis between the adjacent pairs of dielectric layers 11, and a pair of external electrodes 20 provided on the surface of the element body 10 and electrically connected to the internal electrode layers 12. The dielectric layers 11, internal electrode layers 12, second segregation parts 40, and external electrodes 20 are explained below.

### (2) Dielectric Layers

### (2-1) Components Contained in Dielectric Layers

The dielectric layers 11 contain a compound expressed by the general formula ABO_{3-α} (0≤α≤1) and having a perovskite structure. The dielectric layers 11 may also contain additives if necessary.

### <Compound Having Perovskite Structure>

The compound having a perovskite structure, if of a stoichiometric composition, is expressed by a general formula ABO₃ because a representing an amount deviating from a stoichiometric composition is 0. The compound having a perovskite structure and expressed by the general formula may be such that α is greater than 0 but no greater than 1. In other words, the compound having a perovskite structure and expressed by the general formula may be more oxygen-deficient than a stoichiometric composition.

In the general formula ABO_{3-α}, preferably “A” represents one or more types of elements selected from the group that consists of Ba (barium), Sr (strontium), Ca (calcium), and Mg (magnesium). In the general formula ABO_{3-α}, preferably “B” represents one or more types of elements selected from the group that consists of Ti (titanium), Zr (zirconium), and Hf (hafnium). In the compound expressed by the general formula ABO_{3-α} and having a perovskite structure, the elements “A” and “B” are respectively positioned at the A site and B site of the perovskite structure.

Specific examples of the compound having a perovskite structure include one or more types selected from the group that consists of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-Z}Zr_{z}O₃ (0≤x≤1, 0≤y≤1, 0≤z≤1) forming a perovskite structure.

Ba_{1-x-y}CaₓSr_{y}Ti_{1-Z}Zr_{z}O₃ encompasses, for example, barium strontium titanate, barium calcium titanate, barium zirconate, barium zirconate titanate, calcium zirconate titanate, barium calcium zirconate titanate, and the like. It should be noted that, no matter which material it is, the compound having a perovskite structure may contain oxygen deficiency.

Preferably the dielectric layers 11 contain barium titanate, for its superior dielectric properties, as the compound having a perovskite structure, or it may contain barium titanate as the main component, or it may be constituted only by barium titanate. Barium titanate has excellent dielectric properties supported by extremely high relative dielectric constant, small dielectric loss, and the like. Accordingly, the capacitance of the multilayer ceramic capacitor 100 can be increased when its dielectric layers 11 contain barium titanate as the compound having a perovskite structure.

In this Specification, the “main component” refers to the component accounting for the largest amount, by atomic percentage of substance, of all components that are contained.

Also, in the dielectric layers 11, the compound having a perovskite structure may be contained as the main component. The dielectric layers 11, for example, may contain the compound having a perovskite structure by 50% by mol or more, or 90% by mol or more, or they may be constituted only by the compound having a perovskite structure.

### <Additives>

The dielectric layers 11 can also contain additives as optional components.

The additives to be contained in the dielectric layers 11 are not specifically limited and include, for example: oxides containing one or more types of elements selected from the group that consists of zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); oxides containing one or more types of elements selected from the group that consists of cobalt (Co), nickel (Ni), lithium (Li), boron (B), sodium (Na), potassium (K), and silicon (Si); glasses containing one or more types of elements selected from the group that consists of cobalt, nickel, lithium, boron, sodium, potassium, and silicon; and the like.

### (2-2) Average Dielectric Layer Thickness

The average dielectric layer 11 thickness is not specifically limited, but it is preferably 1.0 μm or less, or more preferably 0.8 μm or less, or yet more preferably 0.5 μm or less, for example, from the viewpoint of making the multilayer ceramic capacitor 100 smaller while also increasing the number of laminated layers to allow for increase in capacitance. Also, the average dielectric layer 11 thickness is preferably 0.2 μm or more, or more preferably 0.4 μm or more, for example, from the viewpoint of increasing the productivity and yield. The average dielectric layer 11 thickness can be defined by any combination of a lower-limit value and an upper-limit value as deemed appropriate, and is preferably 0.2 μm or more but no more than 1.0 μm, or more preferably 0.2 μm or more but no more than 0.8 μm, or yet more preferably 0.4 μm or more but no more than 0.8 μm, or most preferably 0.4 μm or more but no more than 0.5 μm.

To evaluate the average dielectric layer 11 thickness, the multilayer ceramic capacitor 100 is polished along the Y-axis to prepare a sample that has been polished down to the center along the Y-axis to expose an XZ-plane in which the dielectric layers 11 and internal electrode layers 12 are laminated, as shown in FIGS. 1 and 2. Within the exposed XZ-plane, two dielectric layers 11 positioned at the center along the Z-axis being the first axis are selected, and additionally two dielectric layers 11 positioned at the top edge, and two positioned at the bottom edge, along the Z-axis being the first axis are selected. In doing so, the dielectric layers 11 to be selected are chosen from inside a capacitive part 14.

Then, each selected dielectric layer 11 is measured for thickness at the center along the X-axis being the second axis, to obtain the thickness of the dielectric layer 11. The same procedure is followed to measure the thicknesses of all six selected dielectric layers 11 to calculate the average value. This average value is defined as the average dielectric layer 11 thickness in the multilayer ceramic capacitor 100. It should be noted that the dielectric layer 11 thickness can be measured using a scanning electron microscope (SEM) or scanning transmission electron microscope (STEM). Since the dielectric layers 11 and internal electrode layers 12 have different compositional makeups, they are discriminated by differences in brightness when observed on electron beam images.

### (3) Internal Electrode Layers

As illustrated in FIG. 2, the region where the first internal electrode layers 12a connected to the first external electrode 20a and second internal electrode layers 12b connected to the second external electrode 20b are facing one another represents a region of the multilayer ceramic capacitor 100 where electrical capacitance is generated. Accordingly, this region where electrical capacitance is generated is referred to as the “capacitive part 14.” In other words, the capacitive part 14 represents the region where each adjacent pair of the internal electrode layers 12 connected to the different external electrodes 20 are facing each other.

The region where the first internal electrode layers 12a connected to the first external electrode 20a are facing one another in the lamination direction without the second internal electrode layers 12b connected to the second external electrode 20b in between, is referred to as a “first end margin 15a.” Also, the region where the second internal electrode layers 12b connected to the second external electrode 20b are facing one another in the lamination direction without the first internal electrode layers 12a connected to the first external electrode 20a in between, is referred to as a “second end margin 15b.” The first end margin 15a and second end margin 15b represent regions where the internal electrode layers 12 connected to the same external electrode 20 are facing one another in the lamination direction without the internal electrode layers 12 connected to the different external electrode 20 in between. The first end margin 15a and second end margin 15b are regions where electrical capacitance is not generated.

Side margins 16 represent regions provided on the outer side of the capacitive part 14 along the third axis being orthogonal to the lamination direction and also orthogonal to the second axis, or in the direction along the Y-axis in the example of FIG. 3. In other words, the side margins 16 are regions adjoining, and on the outer side of, the capacitive part 14 as viewed from the lamination direction, and regions adjoining, and on the outer side of, the capacitive part 14 on the sides to which the internal electrode layers 12 are not extracted. The side margins 16, too, are regions where electrical capacitance is not generated.

### (3-1) Components Contained in Internal Electrode Layers

FIG. 5 is an enlarged partial cross-sectional view of dielectrics layers 11 and an internal electrode layer 12. The internal electrode layer 12 comprises a first phase 17 that contains nickel (Ni) and copper (Cu), as well as a co-existent material 18, and has, at the interfaces between the first phase 17 and particles of the co-existent material 18, first segregation parts 50 where copper, being a metal added in the internal electrode layer 12, has segregated. The concentration of copper in the first segregation parts 50 is higher than the concentration of copper in the first phase 17.

### <First Phase>

Preferably the first phase 17 in the internal electrode layers 12 contains nickel as the main component for its excellent electrical properties and ability to reduce cost.

The content of copper in the first phase 17 in the internal electrode layers 12 is not specifically limited, but from the viewpoint of connectivity between the internal electrode layers 12 and external electrodes 20, the content of copper relative to nickel is preferably 1 at % or higher but no higher than 11 at %, or more preferably 1 at % or higher but no higher than 6 at %. Also, the content of copper in the first phase 17 in the internal electrode layers 12 is preferably 1 at % or higher but no higher than 11 at %, or more preferably 3 at % or higher but no higher than 11 at %, based on the content of copper relative to nickel, from the viewpoint of reliability. Additionally, the content of copper in the first phase 17 in the internal electrode layers 12 is yet more preferably 3 at % or higher but no higher than 6 at %, based on the content of copper relative to nickel, from the overall viewpoint of connectivity between the internal electrode layers 12 and external electrodes 20 as well as reliability. It should be noted that the content of copper relative to nickel represents the atomic ratio of copper when that of nickel is 100 at %.

The first phase 17 in the internal electrode layers 12 may contain, besides nickel and copper, other components generally used in the internal electrode layers of multilayer ceramic capacitors. Such other components generally used in the internal electrode layers of multilayer ceramic capacitors include, for example: tin (Sn) and other base metals or alloys containing the same; platinum (Pt), palladium (Pd), silver (Ag), gold (Au) and other noble metals or alloys containing the same; and the like. Any one type of these may be used alone, or two or more types may be combined.

A high content of other components besides nickel and copper in the first phase 17 in the internal electrode layers 12 may make it difficult for the copper in the internal electrode layers 12 to diffuse to the external electrodes 20, resulting in poor connectivity between the internal electrode layers 12 and external electrodes 20 as well as poor reliability. Accordingly, in the first phase 17 in the internal electrode layers 12, the content of other components relative to nickel is preferably 0.5 at % or lower, or more preferably 0.1 at % or lower, or yet more preferably 0 at %. It should be noted that the content of other components relative to nickel represents the atomic ratio of other components when that of nickel is 100 at %.

The contents of nickel, copper, and other components in the first phase 17 in the internal electrode layers 12 can be confirmed by performing an element analysis of the internal electrode layers 12 using any of various types of measuring equipment and calculating the atomic ratio of each component relative to all detected elements. Regarding the measuring equipment for element analysis, an energy dispersive X-ray spectrometer (EDS), wavelength dispersive X-ray spectrometer (WDS), electron probe micro analyzer (EPMA), laser ablation inductively coupled plasma mass spectrometer (LA-ICP-MS), or the like, installed on a scanning electron microscope (SEM) or scanning transmission electron microscope (STEM), can be used.

### <Co-Existent Material>

The co-existent material 18 is not specifically limited and may be, for example, the same as the ceramic material being the main component of the dielectric layers 11. Preferably the co-existent material 18 contains a compound expressed by the general formula ABO_{3-α} (0≤α1) and having a perovskite structure.

Specific examples of the co-existent material 18 include one or more types selected from the group that consists of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-Z}Zr_{z}O₃ (0≤x≤1, 0≤y≤1, 0≤z≤1) forming a perovskite structure.

Ba_{1-x-y}CaₓSr_{y}Ti_{1-Z}Zr_{z}O₃ encompasses, for example, barium strontium titanate, barium calcium titanate, barium zirconate, barium zirconate titanate, calcium zirconate titanate, barium calcium zirconate titanate, and the like. It should be noted that, no matter which material it is, the compound having a perovskite structure may contain oxygen deficiency.

The particle size of the co-existent material 18 is not specifically limited, but it is preferably smaller than the internal electrode layer 12 thickness, and from the viewpoint of making the internal electrode layers 12 thinner, it is more preferably 10 to 100 nm, or yet more preferably 10 to 50 nm.

The content of the co-existent material 18 in the internal electrode layers 12 is not specifically limited, but it is preferably 2% by mass or higher, or more preferably 5% by mass or higher, or yet more preferably 7% by mass or higher. When the content of the co-existent material 18 in the internal electrode layers 12 is 2% by mass or higher, an effect of delaying the sintering of the internal electrode layers 12 can be achieved. Also, the upper-limit value of the content of the co-existent material 18 in the internal electrode layers 12, which is not specifically limited, either, is preferably 20% by mass or lower, or more preferably 15% by mass or lower, or yet more preferably 12% by mass or lower. When the content of the co-existent material 18 in the internal electrode layers 12 is 20% by mass or lower, the co-existent material diffuses favorably from the internal electrode layers 12 to the dielectric layers 11 in the sintering stage, resulting in improved reliability. The content of the co-existent material 18 in the internal electrode layers 12 can be defined by any combination of an upper-limit value and a lower-limit value as deemed appropriate, but it is preferably 2% by mass or higher but no higher than 20% by mass, or more preferably 5% by mass or higher but no higher than 15% by mass, or yet more preferably 7% by mass or higher but no higher than 12% by mass. It should be noted that the content of the co-existent material 18 in the internal electrode layers 12 represents the ratio by mass of the co-existent material when the content of nickel in the internal electrode layers 12 is 100% by mass. The content of the co-existent material 18 in the internal electrode layers 12 can be calculated from the amounts of materials input when internal electrode layers 12 are produced.

For the amount of co-existent material 18 remaining in the internal electrode layers 12, the area ratio of co-existent material can also be used as an indicator. This can be obtained, for example, from the cross-section area of the co-existent material 18 relative to the cross-section area of the internal electrode layers 12 in a cross-section in the direction of the first axis, which also represents an XZ-section, of the multilayer ceramic capacitor 100 as shown in FIG. 2. To be specific, an arbitrary region in one arbitrarily selected internal electrode layer 12 in the cross-section in the direction of the first axis is observed using a BF-STEM (bright field scanning transmission electron microscope) at a magnification of ×80000, to obtain the overall area of the one internal electrode layer 12 in the view field of the observed BF-STEM image. This is done in the same manner for arbitrary regions in two other arbitrarily selected internal electrode layers 12 in the cross-section in the direction of the first axis, and the overall area of the three internal electrode layers 12 is obtained. Also, the diameter of each of the particles of the co-existent material 18 in the three internal electrode layers 12 is measured to calculate the area of the one co-existent material particle from the diameter of the particle of the co-existent material 18, and the total area of the co-existent material 18 in the three internal electrode layers 12 is calculated. From these calculated values, the area ratio of co-existent material is obtained based on the formula below:

Area ratio of co-existent material (%)=Total area of co-existent material 18/Overall area of internal electrode layers 12×100

The area ratio of co-existent material is not specifically limited, but it is preferably 3% or lower, or more preferably 2% or lower, or yet more preferably 1.5% or lower. When the area ratio of co-existent material is 3% or lower, the co-existent material diffuses favorably from the internal electrode layers 12 to the dielectric layers 11 in the sintering stage, resulting in improved reliability. Additionally, the lower-limit value of the area ratio of co-existent material, which is not specifically limited, either, is preferably 0.5% or higher, or more preferably 0.75% or higher, or yet more preferably 1% or higher. When the area ratio of co-existent material is 0.5% or higher, the co-existent material diffuses favorably from the internal electrode layers 12 to the dielectric layers 11 in the sintering stage, resulting in improved reliability. The area ratio of co-existent material can be defined by any combination of an upper-limit value and a lower-limit value as deemed appropriate, but it is preferably 0.5% or higher but no higher than 3%, or more preferably 0.75% or higher but no higher than 2%, or yet more preferably 1% or higher but no higher than 1.5%.

### <First Segregation Parts>

The first segregation parts 50 are regions where copper, being a metal added in the internal electrode layers 12, has segregated at the interfaces between the first phase 17 and particles of the co-existent material 18 in the internal electrode layers 12. Adding copper, or preferably copper oxide, when internal electrode layers 12 are manufactured, forms first segregation parts 50 at the interfaces between the first phase 17 and particles of the co-existent material 18.

The capacitance of the multilayer ceramic capacitor 100 is expressed by the formula below. Accordingly, making the dielectric layers 11 and internal electrode layers 12 thinner to increase the capacity per unit volume, increasing the numbers of dielectric layers 11 and internal electrode layers 12 that are laminated, and the like, are considered as ways to achieve a size reduction and capacity increase of the multilayer ceramic capacitor 100.

$$C = {ε}_{0} \times {ε}_{r} \times \frac{( n - 1 ) \times S}{t} \qquad [ Math . 1 ]$$

(It should be noted that, in the formula, C indicates the capacitance, ε0 indicates the vacuum dielectric constant, εr indicates the relative dielectric constant of the dielectric layer, n indicates the number of laminated layers, S indicates the area of intersection, and T indicates the inter-electrode distance.)

However, the sintering temperature of the dielectric layers is traditionally higher than the sintering temperature of the internal electrode layers, which means that making the internal electrode layers thinner lowers the continuity rate of the internal electrode layers when they are sintered in a temperature range where the dielectric layers densify. A lower continuity rate of the internal electrode layers reduces the connectivity, and worsens the electrical continuity, between the internal electrode layers and external electrodes, presenting a problem that the desired properties are not achieved.

In contrast, the multilayer ceramic capacitor 100 in the present disclosure allows the sintering of the internal electrode layers 12 to be delayed because the internal electrode layers 12 contain the co-existent material 18. On the other hand, the resistance of the internal electrode layers 12 can increase and lead to lower reliability as a result of the co-existent material 18 remaining in the internal electrode layers 12. However, the multilayer ceramic capacitor 100 in the present disclosure allows the co-existent material 18 to be expelled favorably from the internal electrode layers 12 at the time of sintering because the internal electrode layers 12 contain copper in addition to nickel being the main component, or more specifically because a metal paste containing copper oxide in addition to nickel is used when internal electrode layers 12 are manufactured. It is considered that this is due to the presence, around the particles of the co-existent material 18, or specifically at the interfaces between the first phase 17 and particles of the co-existent material 18, in the internal electrode layers 12, of the first segregation parts 50 where copper having high diffusibility has segregated. The co-existent material 18, having the first segregation parts 50 of copper, diffuses from the internal electrode layers 12 toward the external electrodes 20 at the time of sintering due to the diffusibility of copper, and the co-existent material 18 is expelled to the external electrodes 20. As this happens, flows of copper are generated to improve the connectivity between the internal electrode layers 12 and external electrodes 20. The result is an improved connectivity between the internal electrode layers 12 and external electrodes 20 as well as increased capacity. Additionally, the co-existent material 18 remaining in the internal electrode layers 12 decreases, which also improves reliability. Accordingly, the multilayer ceramic capacitor 100 in the present disclosure can achieve an improved connectivity between the internal electrode layers 12 and external electrodes 20 along with an improved reliability.

Presence of first segregation parts 50 at the interfaces between the first phase 17 and particles of the co-existent material 18 can be confirmed by observing that copper is concentrated at the interfaces between the first phase 17 and particles of the co-existent material 18 using an energy dispersive X-ray spectrometer (EDS), wavelength dispersive X-ray spectrometer (WDS), electron probe micro analyzer (EPMA), laser ablation inductively coupled plasma mass spectrometer (LA-ICP-MS), or the like, installed on a scanning transmission electron microscope (STEM).

The concentration of copper in the first segregation parts 50 is higher than the concentration of copper in the first phase 17. The concentrations of copper in the first segregation parts 50, and in the first phase 17, are measured by performing an element analysis using a scanning transmission electron microscope (STEM).

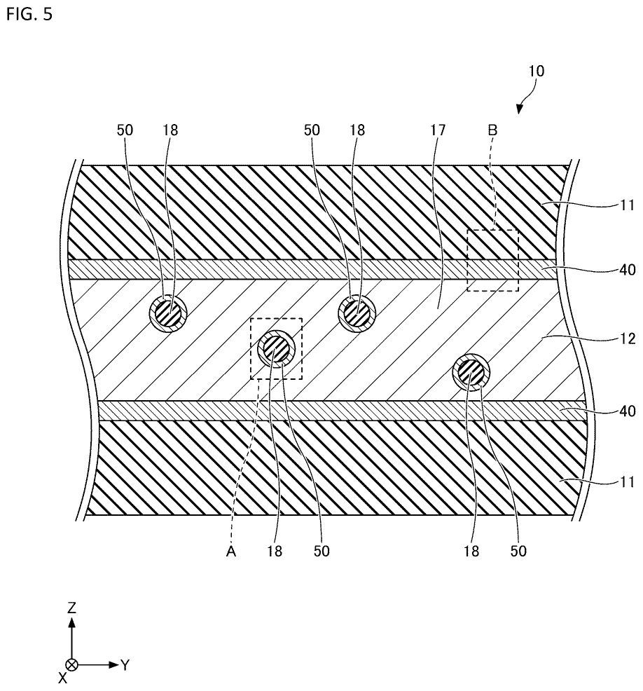

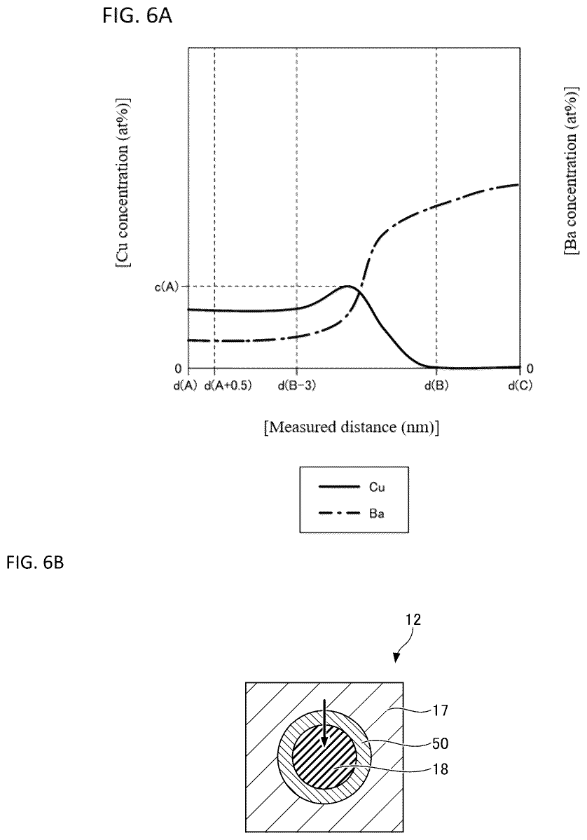

FIG. 6A is a drawing explaining a method for measuring the concentration of copper in a first segregation part 50. FIG. 6B is an enlarged view of region A in FIG. 5 and a drawing explaining the measuring direction for measuring the concentration of copper in a first segregation part 50. The method for measuring the concentration of copper in a first segregation part 50 is explained based on FIG. 6A using an example where the main component of the co-existent material 18 is barium titanate. As shown in FIGS. 1 and 2, the multilayer ceramic capacitor 100 is polished along the Y-axis to prepare a sample that has been polished down to the center along the Y-axis to expose an XZ-plane in which the dielectric layers 11 and internal electrode layers 12 are laminated. The interface between the first phase 17 and a particles of the co-existent material 18 in an internal electrode layer 12 within the exposed XZ-plane is measured in the direction from the first phase 17 side to the co-existent material 18 side (direction of the arrow in FIG. 6B) in the internal electrode layer 12, using a STEM, to perform an element analysis. Based on the profile data of copper obtained from the element analysis, as measured in the direction from the first phase 17 side to the co-existent material 18 side in the internal electrode layer 12, the position of the end part at which the measurement on the first phase 17 side in the internal electrode layer 12 is started is given by “position A,” while the distance from position A to an arbitrary position x is indicated by “measured distance d(x) nm,” and then the measured distance of position A is indicated by “d(A) nm”=0 nm. The measured distance from position A to position B at which the Cu concentration drops to baseline B is indicated by “d(B) nm.” Next, when the position being the end part at which the measurement in FIG. 6A is terminated is given by “position C,” its measured distance is indicated by “d(C) nm.” The average value of Cu concentration in the range from position B to position C, or specifically range from measured distance d(B) nm to measured distance d(C) nm, is defined as the Cu concentration at baseline B. From this, the average value of Cu concentration in the co-existent material 18 is obtained. Next, when the position achieved by moving position B by 3 nm to the position A side is given by “position (B-3),” the peak Cu concentration c(A) in the range from position (B-3) to position B, or specifically range from measured distance d(B-3) nm to d(B) nm, is measured, and from this, the peak Cu concentration in the first segregation part 50 is obtained.

In the present disclosure, the position achieved by advancing the measurement by 0.5 nm from position A being the end part at which the measurement on the first phase 17 side in the internal electrode layer 12 is started is given by “position (A+0.5),” the average value of Cu concentration in the range from position A to position (A+0.5), or specifically range from d(A) nm to d(A+0.5) nm, is defined as the “concentration of copper in the first phase 17,” and the aforementioned peak Cu concentration c(A) in the range from d(B-3) nm to d(B) nm is defined as the “concentration of copper in the first segregation part 50.” In other words, the expression, in the present disclosure, of the concentration of copper in the first segregation part 50 being “higher” than the concentration of copper in the first phase 17 means that the peak Cu concentration c(A) in the range from d(B-3) nm to d(B) nm is higher than the average value of Cu concentration from the end part d(A) nm at which the measurement on the first phase 17 side in the internal electrode layer 12 is started, to d(A+0.5) nm.

When the Cu concentration at baseline B is 100%, the peak Cu concentration c(A), which is not specifically limited so long as it exceeds 100%, is preferably 120% or higher, or more preferably 130% or higher. When the Cu concentration at baseline B is 100%, the upper-limit value of peak Cu concentration c(A), which is not specifically limited, is more preferably 200% or lower.

The peak Cu concentration c(A), which is not specifically limited so long as it is higher than the peak Cu concentration in the first phase 17, is preferably 1.20 at % or higher, or more preferably 4.0 at % or higher. The upper-limit value of peak Cu concentration c(A), which is not specifically limited, is more preferably 16 at % or lower.

It suffices that a first segregation part 50 is provided at the interface between the first phase 17 and a particle of the co-existent material 18, or specifically around the particle of the co-existent material 18, at least partially. This means that a first segregation part 50 may be provided continuously, or it may be provided discontinuously, at the interface between the first phase 17 and a particle of the co-existent material 18.

### (3-2) Average Internal Electrode Layer Thickness

The average internal electrode layer 12 thickness is not specifically limited, but it is preferably 0.8 μm or less, or more preferably 0.6 μm or less, or yet more preferably 0.4 μm or less, for example, from the viewpoint of making the multilayer ceramic capacitor 100 smaller while also increasing the number of laminated layers to allow for increase in capacitance. Also, the average internal electrode layer 12 thickness is preferably 0.2 μm or more, or more preferably 0.3 μm or more, for example, from the viewpoint of increasing the productivity and yield. The average internal electrode layer 12 thickness can be defined by any combination of an upper-limit value and a lower-limit value as deemed appropriate, but it is preferably 0.2 μm or more but no more than 0.8 μm, or more preferably 0.2 μm or more but no more than 0.6 μm, or yet more preferably 0.3 μm or more but no more than 0.6 μm, or most preferably 0.4 μm or more but no more than 0.6 μm.

To evaluate the average internal electrode layer 12 thickness, the multilayer ceramic capacitor 100 is polished along the Y-axis to prepare a sample that has been polished down to the center along the Y-axis to expose an XZ-plane in which the dielectric layers 11 and internal electrode layers 12 are laminated, as shown in FIGS. 1 and 2. Within the exposed XZ-plane, two internal electrode layers 12 positioned at the center along the Z-axis being the first axis are selected, and additionally two internal electrode layers 12 positioned at the top edge, and two positioned at the bottom edge, along the Z-axis being the first axis are selected. In doing so, the internal electrode layers 12 to be selected are chosen from inside the capacitive part 14.

Then, each selected internal electrode layer 12 is measured for thickness at the center along the X-axis being the second axis, to obtain the thickness of the internal electrode layer 12. The same procedure is followed to measure the thicknesses of all six internal electrode layers 12 to calculate the average value. This average value is defined as the average internal electrode layer 12 thickness in the multilayer ceramic capacitor 100. It should be noted that the internal electrode layer 12 thickness can be measured using a scanning electron microscope (SEM) or scanning transmission electron microscope (STEM).

### (4) Second Segregation Parts

The second segregation parts 40 are regions where copper, being a metal added in the internal electrode layers 12, has segregated at the interfaces between the dielectric layers 11 and internal electrode layers 12. To be specific, they are regions where copper, being a metal added in the internal electrode layers 12, has segregated at the interfaces between the dielectric layers 11 and first phase 17 in the internal electrode layers 12. Adding copper, or preferably copper oxide, when internal electrode layers 12 are manufactured, forms first segregation parts 50 at the interfaces between the first phase 17 and particles of the co-existent material 18, while at the same time forms second segregation parts 40 favorably at the interfaces between the dielectric layers 11 and internal electrode layers 12. The multilayer ceramic capacitor 100 in the present disclosure, by virtue of having the second segregation parts 40, allows the co-existent material 18 to be expelled favorably to the dielectric layers 11 at the time of sintering, which improves the reliability further.

Presence of second segregation parts 40 at the interfaces between the dielectric layers 11 and internal electrode layers 12 can be confirmed by observing that copper is concentrated at the interfaces between the dielectric layers 11 and internal electrode layers 12 using an energy dispersive X-ray spectrometer (EDS) or wavelength dispersive X-ray spectrometer (WDS), electron probe micro analyzer (EPMA), laser ablation inductively coupled plasma mass spectrometer (LA-ICP-MS), or the like, installed on a scanning transmission electron microscope (STEM).

The concentration of copper in the second segregation parts 40 is higher than the concentration of copper in the first phase 17 of the internal electrode layers 12. The concentrations of copper in the second segregation parts 40, and in the first phase 17, are measured by performing an element analysis using a scanning transmission electron microscope (STEM).

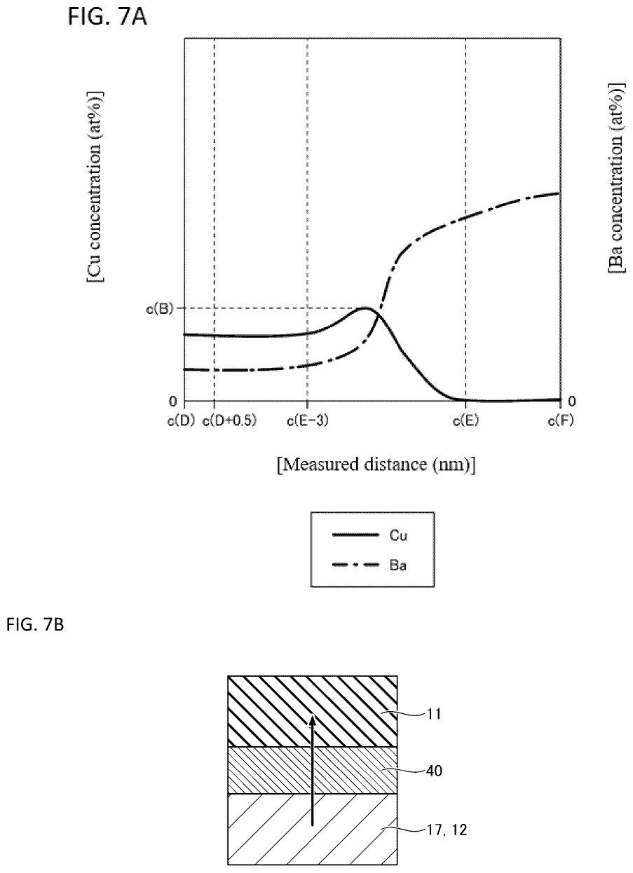

FIG. 7A is a drawing explaining a method for measuring the concentration of copper in a second segregation part 40. FIG. 7B is an enlarged view of region B in FIG. 5 and a drawing explaining the measuring direction for measuring the concentration of copper in a second segregation part 40. The method for measuring the concentration of copper in a second segregation part 40 is explained based on FIG. 7A using an example where the main component of the dielectric layers 11 is barium titanate. As shown in FIGS. 1 and 2, the multilayer ceramic capacitor 100 is polished along the Y-axis to prepare a sample that has been polished down to the center along the Y-axis to expose an XZ-plane in which the dielectric layers 11 and internal electrode layers 12 are laminated. Within the exposed XZ-plane, the interface between the first phase 17 in an internal electrode layer 12, and a dielectric layer 11, is measured in the direction from the first phase 17 side in the internal electrode layer 12 to the dielectric layer 11 side (direction of the arrow in FIG. 7B), using a STEM, to perform an element analysis. Based on the profile data of copper obtained from the element analysis, as measured in the direction from the first phase 17 side in the internal electrode layer 12 to the dielectric layer 11 side, the position of the end part at which the measurement on the first phase 17 side in the internal electrode layer 12 is started is given by “position D,” while the distance from position D to an arbitrary position x is indicated by “measured distance d(x) nm,” and then the measured distance of position D is indicated by “d(D) nm”=0 nm. The measured distance from position D to position E at which the Cu concentration drops to baseline E is indicated by “d(E) nm.” Next, when the position being the end part at which the measurement in FIG. 7A is terminated is given by “position F,” its measured distance is indicated by “d(F) nm.” The average value of Cu concentration in the range from position E to position F, or specifically range from measured distance d(E) nm to measured distance d(F) nm, is defined as the Cu concentration at baseline E. From this, the average value of Cu concentration in the dielectric layer 11 is obtained. Next, when the position achieved by moving position E by 3 nm to the position D side is given by “position (E-3),” the peak Cu concentration c(B) in the range from position (E-3) to position E, or specifically range from measured distance d(E-3) nm to d(E) nm, is measured, and from this, the peak Cu concentration in the second segregation part 40 is obtained.

In the present disclosure, the position achieved by advancing the measurement by 0.5 nm from position D being the end part at which the measurement on the first phase 17 side in the internal electrode layer 12 is started is given by “position (D+0.5),” the average value of Cu concentration in the range from position D to position (D+0.5), or specifically range from d(D) nm to d(D+0.5) nm, is defined as the “concentration of copper in the first phase 17,” and the aforementioned peak Cu concentration c(B) in the range from d(E-3) nm to d(E) nm is defined as the “concentration of copper in the second segregation part 40.” In other words, the expression, in the present disclosure, of the concentration of copper in the second segregation part 40 being “higher” than the concentration of copper in the first phase 17 means that the peak Cu concentration c(B) in the range from d(E-3) nm to d(E) nm is higher than the average value of Cu concentration from the end part d(D) nm at which the measurement on the first phase 17 side in the internal electrode layer 12 is started, to d(D+0.5) nm.

When the Cu concentration at baseline E is 100%, the peak Cu concentration c(B), which is not specifically limited so long as it exceeds 100%, is preferably 120% or higher, or more preferably 130% or higher. When the Cu concentration at baseline E is 100%, the upper-limit value of peak Cu concentration c(B), which is not specifically limited, is more preferably 200% or lower.

The peak Cu concentration c(B), which is not specifically limited so long as it is higher than the peak Cu concentration in the first phase 17, is preferably 1.20 at % or higher, or more preferably 3.0 at % or higher. The upper-limit value of peak Cu concentration c(B), which is not specifically limited, is more preferably 15 at % or lower.

It suffices that a second segregation part 40 is provided at the interface between a dielectric layer 11, and the first phase 17 in an internal electrode layer 12, at least partially. This means that a second segregation part 40 may be provided continuously, or it may be provided discontinuously, at the interface between a dielectric layer 11 and the first phase 17 in an internal electrode layer 12.

### (5) External Electrodes

The external electrodes 20 are provided on the first side face 10a and second side face 10b being the surfaces of the element body 10, and electrically connected to the internal electrode layers 12. The external electrodes 20 may have one or more plating layers on their surface on the opposite side to one on which the element body 10 is located.

### (5-1) Components Contained in External Electrodes

Preferably the external electrodes 20 contain Ni as the main component. Also, the external electrodes 20 may, besides nickel, contain other components used in the external electrodes 20 of multilayer ceramic capacitors 100. Such other components used in the external electrodes 20 of multilayer ceramic capacitors 100 include, for example: tin (Sn) and other base metals or alloys containing the same; copper (Cu), platinum (Pt), palladium (Pd), silver (Ag), gold (Au) and other noble metals or alloys containing the same; and the like. Any one type of these may be used alone, or two or more types may be combined.

If the external electrodes 20 contain copper, preferably the concentration of copper is different between the external electrodes 20 and regions in the internal electrode layers 12 near the external electrodes 20, from the viewpoint of promoting the expelling of the co-existent material 18 in the internal electrode layers 12 to the external electrodes 20 at the time of sintering, which means that preferably the concentration of copper in the external electrodes 20 is lower than the concentration of copper in the first end margin 15a and second end margin 15b of the internal electrode layers 12.

The ratio of the concentration of copper in the external electrodes 20 to the concentration of copper in the internal electrode layers 12 is not specifically limited, but the ratio [concentration of copper in external electrodes 20/concentration of copper in internal electrode layers 12] is preferably 0.3 or higher but no higher than 0.5, or more preferably 0.2 or higher but no higher than 0.4, or yet more preferably 0.1 or higher but no higher than 0.2.

Also, the external electrodes 20 may contain a co-existent material in the form of ceramic grains. The co-existent material in the external electrodes 20 may be the same as the co-existent material 18 in the internal electrode layers 12, and preferably contains a compound expressed by the general formula ABO_{3-α} (0≤α≤1) and having a perovskite structure.

The content of the co-existent material in the external electrodes 20 is not specifically limited, but it is preferably 5% by mass or higher, or more preferably 10% by mass or higher, or yet more preferably 15% by mass or higher. Additionally, the upper-limit value of the content of the co-existent material in the external electrodes 20, which is not specifically limited, either, is preferably 40% by mass or lower, or more preferably 35% by mass or lower, or yet mor preferably 30% by mass or lower. The content of the co-existent material in the external electrodes 20 can be defined by any combination of an upper-limit value and a lower-limit value as deemed appropriate, but it is preferably 5% by mass or higher but no higher than 40% by mass, or more preferably 10% by mass or higher but no higher than 35% by mass, or yet more preferably 15% by mass or higher but no higher than 30% by mass. It should be noted that the content of the co-existent material in the external electrodes 20 represents the ratio by mass of the co-existent material when the content of nickel in the external electrodes 20 is 100% by mass. The content of the co-existent material in the external electrodes 20 can be calculated from the amounts of materials input when external electrodes 20 are produced.

The multilayer ceramic electronic component in this embodiment can be manufactured favorably by the method for manufacturing the multilayer ceramic electronic component in this embodiment as described below.

### [Method for Manufacturing Multilayer Ceramic Capacitor]

The method for manufacturing multilayer ceramic electronic component in the present disclosure includes an internal electrode layer pattern-forming step, a laminated body-forming step, an external electrode precursor-forming step, a first heating step, and a second heating step. The method for manufacturing multilayer ceramic electronic component in the present disclosure may also include other steps such as a raw material powder preparation step, a slurry preparation step, a coating step, a pressure-bonding step, a singulation step, a reoxidation treatment step, and a plating treatment step.

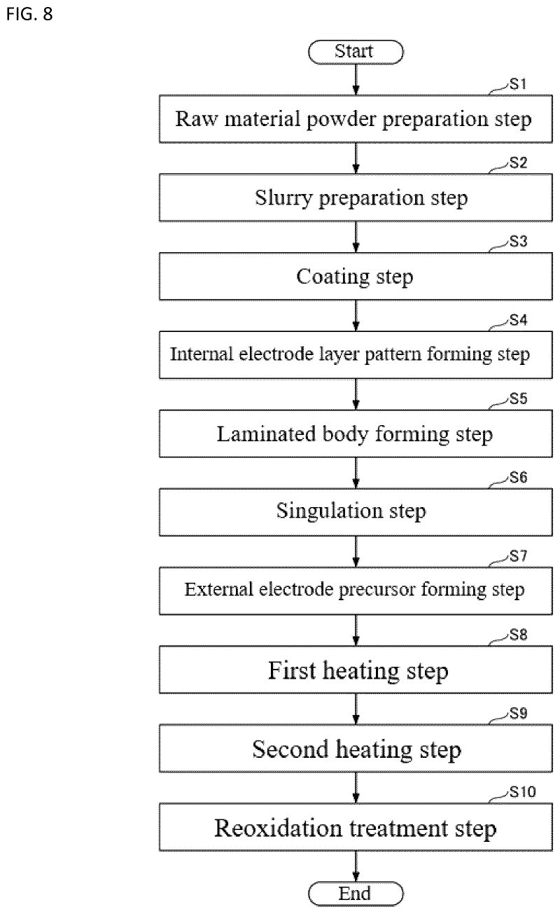

FIG. 8 is a flow chart of a method for manufacturing the multilayer ceramic capacitor 100 pertaining to an embodiment of the present disclosure.

### (1) Raw Material Powder Preparation Step (S1)

In the raw material powder preparation step (S1), a raw material powder for ceramic is prepared as a dielectric material with which to form dielectric layers 11. Since the dielectric layers 11 will contain a compound expressed by the general formula ABO_{3-α} (0≤α≤1) and having a perovskite structure, a material from which a ceramic containing a compound expressed by the general formula ABO_{3-α} (0≤α≤1) and having a perovskite structure can be obtained is used as the raw material powder for ceramic.

For example, barium titanate (BaTiO₃) is a tetragonal crystal compound having a perovskite structure and exhibits a high relative dielectric constant. Barium titanate can be obtained, in general, by reacting together titanium dioxide or other titanium material and barium carbonate or other barium material.

For the method for synthesizing the raw material powder for ceramic, various types of methods have heretofore been known, such as the solid phase method, sol-gel method, hydrothermal method, and the like. In this embodiment, any of these can be adopted.

Preferably the number-averaged particle size of the raw material powder for ceramic is 50 to 200 nm from the viewpoint of making the dielectric layers 11 thinner.

In the raw material powder preparation step (Si), specified additives can be added to the raw material powder for ceramic according to the objectives. The additive compounds include: one or more types of elements selected from the group that consists of zirconium (Zr), niobium (Nb), molybdenum (Mo), tantalum (Ta), tungsten (W), magnesium (Mg), manganese (Mn), vanadium (V), and chromium (Cr); oxides containing one or more types of rare earth elements selected from the group that consists of scandium (Sc), yttrium (Y), cerium (Ce), neodymium (Nd), samarium (Sm), europium (Eu), gadolinium (Gd), terbium (Tb), dysprosium (Dy), holmium (Ho), erbium (Er), thulium (Tm), and ytterbium (Yb); oxides containing one or more types of elements selected from cobalt (Co), nickel (Ni), lithium (Li), boron (B), sodium (Na), potassium (K), and silicon (Si); glasses containing one or more types of elements selected from the group that consists of cobalt (Co), nickel (Ni), lithium (Li), boron (B), sodium (Na), potassium (K), and silicon (Si); and the like. Any one type of these may be used alone, or two or more types may be combined. Of these, silicon dioxide (SiO₂), which is an oxide primarily of silicon (Si), functions favorably as a sintering auxiliary agent.

In the raw material powder preparation step (S1), for example, additives as well as compounds including additive compounds can be wet-mixed to the raw material powder for ceramic if necessary, followed by drying and pulverizing, to prepare a raw material powder. Also, following the drying and pulverizing, for example, the raw material powder may be further put through a pulverizing process to adjust the particle size, or the pulverizing process may be combined with a classification treatment to regulate the particle size if necessary. Following the above step, a raw material powder, as the dielectric material, is obtained.

### (2) Slurry Preparation Step (S2)

In the slurry preparation step (S2), a slurry that contains the raw material powder obtained in the raw material powder preparation step (Si) is prepared.

The slurry can contain, besides the raw material powder obtained in the raw material powder preparation step (S1), an organic binder, an organic solvent, a plasticizer, and the like. The organic binder is not specifically limited and any known resin such as polyvinyl butyral (PVB) resin can be used. The organic solvent is not specifically limited and may be, for example, ethanol, toluene, or the like.

The method for preparing the slurry is not specifically limited and may be one that involves, for example, adding together and wet-mixing a raw material powder, an organic binder, an organic solvent, and a plasticizer. It should be noted that, when mixing the raw material powder for ceramic, etc., in the raw material powder preparation step (S1), an organic binder, etc., may also be added and wet-mixed together.

### (3) Coating Step (S3)

In the coating step (S3), the slurry from the slurry preparation step (S2) is coated on a substrate.

In the coating step (S3), the obtained slurry can be coated on the substrate according to the die-coater method or doctor's blade method, for example. This way, a dielectric layer precursor sheet 71 is formed. An example of dielectric layer precursor sheet 71 is a ceramic precursor sheet. The thickness of the dielectric layer precursor sheet 71 can be selected as deemed appropriate according to the intended average dielectric layer 11 thickness.

The substrate is not specifically limited, but preferably it is a material from which the dielectric layer precursor sheet 71 can be released, such as a polyethylene terephthalate (PET) film.

In the coating step (S3), the substrate on which the slurry has been coated may be dried. No drawing is provided that illustrates the coating step (S3).

### (4) Internal Electrode Layer Pattern-Forming Step (S4)

In the internal electrode layer pattern-forming step (S4), an internal electrode layer pattern 72 is formed, using a first metal paste containing nickel (Ni), copper oxide (CuO), and co-existent material 18, on each dielectric layer precursor sheet 71 that contains the raw material powder for ceramic containing the compound expressed by the general formula ABO_{3-α} (0≤α≤1) and having a perovskite structure. To be specific, an internal electrode layer pattern 72 is formed on each dielectric layer precursor sheet 71 obtained in the coating step (S3), using a first metal paste containing nickel, copper oxide, and co-existent material 18.

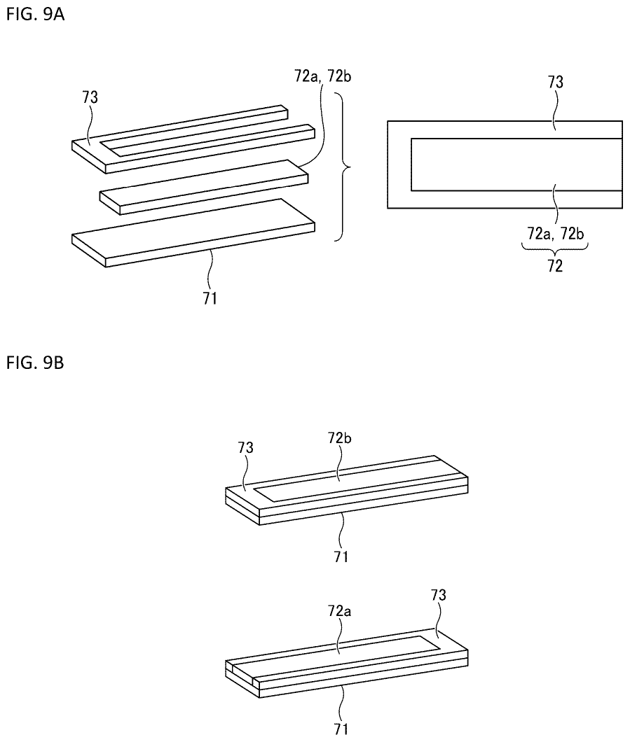

FIG. 9A is a drawing illustrating the internal electrode layer pattern-forming step in the method for manufacturing the multilayer ceramic capacitor pertaining to an embodiment of the present disclosure.

The particle size of copper oxide (CuO) is not specifically limited, but it is preferably smaller than the internal electrode layer 12 thickness, or more preferably 10 to 100 nm from the viewpoint of making the internal electrode layers 12 thinner.

The content of copper oxide (CuO) in the first metal paste is not specifically limited, but it is preferably a content that brings the content of copper (Cu) relative to nickel (Ni) to 1 at % or higher but no higher than 11 at %, or more preferably a content that brings the same to 1 at % or higher but no higher than 6 at %, in the internal electrode layers 12, from the viewpoint of connectivity between the internal electrode layers 12 and external electrodes 20. Also, from the viewpoint of reliability, the content of copper oxide (CuO) in the first metal paste is preferably a content that brings the content of copper (Cu) relative to nickel (Ni) to 1 at % or higher but no higher than 11 at %, or more preferably a content that brings the same to 3 at % or higher but no higher than 11 at %, in the internal electrode layers 12. Additionally, from the overall viewpoint of connectivity between the internal electrode layers 12 and external electrodes 20 as well as reliability, the content of copper oxide (CuO) in the first metal paste is yet more preferably a content that brings the content of copper (Cu) relative to nickel (Ni) to 3 at % or higher but no higher than 6 at % in the internal electrode layers 12. When adding copper oxide (CuO), it may be dispersed beforehand in terpineol or other organic solvent, for example.

As described above, the first internal electrode layers 12a and second internal electrode layers 12b can have nickel (Ni), or an alloy containing nickel (Ni), as the main component. The first metal paste may also contain: tin (Sn) or other base metal or an alloy containing the same; or platinum (Pt), palladium (Pd), silver (Ag), gold (Au) or other noble metal or an alloy containing the same.

First internal electrode layer patterns 72a for first internal electrode layers 12a, and second internal electrode layer patterns 72b for second internal electrode layers 12b, may be formed using metal pastes of the same compositional makeup, or they may be formed using metal pastes of different compositional makeups, so long as the first metal paste containing nickel, copper oxide, and co-existent material 18 is used. In other words, the main component of the first internal electrode layers 12a may be the same as, or different from, the main component of the second internal electrode layers 12b. As an example, the main components of the first internal electrode layers 12a and second internal electrode layers 12b may be the same nickel.

In the internal electrode layer pattern-forming step (S4), the metal paste can be prepared by kneading together nickel, copper oxide, and co-existent material 18, and additionally, other metals or alloys or co-existent materials if necessary.

In the internal electrode layer pattern-forming step (S4), the first metal paste containing nickel, copper oxide, and co-existent material 18 can be printed on the surface of each dielectric layer precursor sheet 71 by means of screen printing, gravure printing, or other printing method, as illustrated in FIG. 9A. Also, the method for forming internal electrode layer patterns in the internal electrode layer pattern-forming step (S4) is not limited to a printing method, and the plating method, vacuum deposition method, sputtering method, or CVD method can be used. This way, a first internal electrode layer pattern 72a for first internal electrode layer 12a or second internal electrode layer pattern 72b for second internal electrode layer 12b is formed on the surface of the dielectric layer precursor sheet 71.

Also, ethyl cellulose-based or other organic binder, and terpineol-based or other organic solvent, can be added to the raw material powder obtained in the raw material powder preparation step (Si), followed by kneading in a roll mill, to obtain a dielectric pattern paste for reverse pattern layers. Then, as illustrated in FIG. 9A, the dielectric pattern paste may be applied into shape to place a dielectric pattern 73 in the peripheral region on the dielectric layer precursor sheet 71 where neither first internal electrode layer pattern 72a nor second internal electrode layer pattern 72b has been formed, to fill the height gap with the first internal electrode layer pattern 72a or second internal electrode layer pattern 72b. A dielectric layer precursor sheet 71 on which an internal electrode layer pattern 72 and a dielectric pattern 73 have been formed is referred to as a “lamination unit.”

### (5) Laminated Body-Forming Step (S5)

In the laminated body-forming step (S5), a laminated body is formed in which multiple dielectric layer precursor sheets 71 on which the internal electrode layer patterns 72 have been formed are laminated along the first axis in such a way that the internal electrode layer patterns 72 are exposed alternately to two opposing end faces.

FIG. 9B is a drawing illustrating the laminated body-forming step in the method for manufacturing the multilayer ceramic capacitor pertaining to an embodiment of the present disclosure.

To be specific, the dielectric layer precursor sheets 71 on which the first internal electrode layer patterns 72a and dielectric pattern 73 have been formed, and dielectric layer precursor sheets 71 on which the second internal electrode layer patterns 72b and dielectric patterns 73 have been formed, are laminated successively, as illustrated in FIG. 9B, while releasing the substrate from each dielectric layer precursor sheet 71. In doing so, preferably the lamination units are laminated in such a way that the internal electrode layers 12 alternate with the dielectric layers 11, and that the edges of the internal electrode layers 12 are exposed alternately to the two end faces of the dielectric layers 11 in the length direction and extracted alternately to the pair of external electrodes.

The number of lamination units to be laminated is not specifically limited and can be selected as deemed appropriate according to the objectives; for example, there may be 100 to 500 layers.

Also, cover layers 13 may be laminated on the upper face and lower face of the laminate of dielectric layer precursor sheets 71. The number of cover layers 13 to be laminated is not specifically limited and can be selected as deemed appropriate according to the objectives; for example, there may be 2 to 10 layers. The cover layers 13 may be constituted by the same components as the dielectric layer precursor sheets 71 or contain different additive compounds.

In the laminated body-forming step (S5), the laminate, or preferably laminate of dielectric layer precursor sheets 71 whose upper face and lower face are covered with the cover layers 13, as obtained per above, can be pressure-bonded under heat to form a laminated body.

### (6) Singulation Step (S6)

In the singulation step (S6), the laminated body obtained in the laminated body-forming step (S5) is singulated.

The method for singulating in the singulation step (S6) is not specifically limited, and a singulating process using a dicer, laser cutting, or other existing method can be used.

The singulating size is not specifically limited and can be selected as deemed appropriate according to the desired size of the multilayer ceramic capacitor 100.

### (7) External Electrode Precursor-Forming Step (S7)

In the external electrode precursor-forming step (S7), a second metal paste containing nickel is applied by any method as deemed appropriate onto the surface of the singulated laminated body, to form precursors to external electrodes. When external electrodes 20 are to be provided on two end faces of the element body 10, preferably the external electrode precursor-forming step (S7) involves applying the second metal paste containing nickel by any method as deemed appropriate on the first side face 10a and second side face 10b, which are two opposing side faces, of the singulated laminated body, thereby forming precursors to external electrodes.

As described above, the external electrodes 20 can have nickel (Ni), or an alloy containing nickel (Ni), as the main component. The second metal paste can also contain a powder of an additive metal element such as: tin (Sn) or other base metal or an alloy containing the same; or copper (Cu), platinum (Pt), palladium (Pd), silver (Ag), gold (Au) or other noble metal or an alloy containing the same. Additionally, the second metal paste may contain a co-existent material and glass component. When the second metal paste is to contain other component such as a powder of additive metal element or co-existent material, the concentration of such other component relative to nickel should be kept low. It should be noted that adding a glass component allows the external electrodes to have less voids inside and also exhibit higher strength.

In the external electrode precursor-forming step (S7), the second metal paste can be prepared from nickel, or by further kneading it together with other metals or alloys or co-existent materials if necessary. If copper is to be added to the second metal paste, copper may be added in a simple substance state, or it may be added in a compound state.

The second metal paste used in the external electrode precursor-forming step (S7) may be the same as, or different from, the first metal paste used in the internal electrode layer pattern-forming step (S4) in compositional makeup, for example.

The method for applying the second metal paste onto the surface of the laminated body is not specifically limited and may be, for example, the dip method, transfer method, or the like.

In the external electrode precursor-forming step (S7), the laminated body on whose surface the second metal paste has been applied may be dried.

### (8) First Heating Step (S8)

In the first heating step (S8), the laminated body on which the precursors to external electrodes have been formed, as obtained in the external electrode precursor-forming step (S7), is heated at 800° C. or higher but no higher than 1000° C.

The heating period in the first heating step (S8) is not specifically limited, but preferably the temperature is held for 3 minutes or longer but no longer than 5 minutes. Preferred in the first heating step (S8), of these conditions, is to hold the laminated body for 3 minutes or longer but no longer than 5 minutes at a temperature of 800° C. or higher but no higher than 1000° C., because doing so facilitates the formation of first segregation parts 50 at the interfaces between the first phase 17 and particles of the co-existent material 18.

Organic binders are generally burned completely at approx. 500° C. Accordingly, any organic binder can be degreased in the first heating step (S8). Although it adds to the step procedure, this degreasing can be made a step independent of the first heating step (S8) and provided between it and the preceding external electrode precursor-forming step (S7), or it can be provided within the external electrode precursor-forming step (S7).

Traditionally, the laminated body on which the precursors to external electrodes have been formed is sintered at a higher rate of temperature rise, which causes the metal paste to sinter before the co-existent material 18 is expelled from the metal paste in the internal electrode layer patterns 72, resulting in the co-existent material 18 remaining in the internal electrode layers 12. In contrast, the method for manufacturing multilayer ceramic electronic component in the present disclosure includes the first heating step (S8) to expel the co-existent material 18 favorably to the external electrodes 20.

The temperature of the laminated body may be raised gradually until the heating temperature reaches 800° C. from room temperature. In this case, the average rate of temperature rise from room temperature to 800° C. is not specifically limited, but because too high a rate of temperature rise can prevent sufficient degreasing with respect to the organic binder in the first metal paste in the internal electrode layer patterns 72, thereby causing problems such as generation of cracks in the second heating step, the average rate of temperature rise is set to preferably 80° C./min or lower, or more preferably 65° C./min or lower.

It should be noted that, even when degreasing is made a step independent of the first heating step (S8) and provided between it and the preceding external electrode precursor-forming step (S7), or within the external electrode precursor-forming step (S7), the degreasing step itself is implemented at an average rate of temperature rise from room temperature to 500° C., of preferably 80° C./min or lower, or more preferably 65° C./min or lower. If degreasing is made a step independent of the first heating step (S8), the average rate of temperature rise in the first heating step (S8) can be set to 200° C./min or higher but no higher than 500° C./min, while setting it to 300° C./min or higher but no higher than 500° C./min can facilitate the formation of first segregation parts 50 at the interfaces between the first phase 17 and particles of the co-existent material 18.

The oxygen partial pressure in the first heating step (S8) is not specifically limited, but it is preferably 10⁻¹⁰ atm or higher but no higher than 10⁻⁷ atm, or more preferably 10⁻⁹ atm or higher but no higher than 10⁻⁷ atm, or yet more preferably 108 atm or higher but no higher than 10⁻⁷ atm.

For the atmosphere condition in the first heating step (S8), a reducing atmosphere is preferred.

### (9) Second Heating Step (S9)

In the second heating step (S9), following the first heating step (S8), the laminated body on which the precursors to external electrodes have been formed is heated so that dielectric layers 11 will be formed from the dielectric layer precursor sheets 71, internal electrode layers 12 will be formed from the internal electrode layer patterns 72, external electrodes 20 will be formed from the precursors to external electrodes, first segregation parts 50 where copper has segregated will be formed at the interfaces between the first phase 17 and particles of the co-existent material 18 in the internal electrode layers 12 that contain the first phase 17 containing nickel and copper along with the co-existent material 18, and the concentration of copper in the first segregation parts 50 will become higher than the concentration of copper in the first phase 17.

The heating temperature in the second heating step (S9) is not specifically limited, but heating at 1100° C. or higher but no higher than 1300° C. is preferred. Also, the heating period in the second heating step (S9) is not specifically limited, but preferably the temperature is held for 10 minutes or longer but no longer than 2 hours. Particularly preferred in the second heating step (S9), of these conditions, is to hold the laminated body completing the first heating step (S8) for 10 minutes or longer but no longer than 2 hours at a temperature of 1100° C. or higher but no higher than 1300° C.

The temperature of the laminated body may be raised gradually until the heating temperature reaches the maximum temperature specified as 1100° C. or higher but no higher than 1300° C., from 1000° C. or lower in the first heating step. In this case, the average rate of temperature rise from 1000° C. or lower to 1100° C. is not specifically limited, but it is set to preferably 50° C./min or higher, or more preferably 100° C./min or higher. Also, the average rate of temperature rise is set to preferably 500° C./min or lower, or more preferably 400° C./min or lower.

The oxygen partial pressure in the second heating step (S9) is not specifically limited, but it is preferably 10⁻¹² atm or higher but no higher than 10⁻⁷ atm, or more preferably 10⁻¹² atm or higher but no higher than 10⁻⁸ atm, or yet more preferably 10⁻¹² atm or higher but no higher than 10⁻⁹ atm.

For the atmosphere condition in the second heating step (S9), a reducing atmosphere is preferred.

### (9) Reoxidation Treatment Step (S10)

In the reoxidation treatment step (S10), heat treatment is performed in a mixed steam gas under a reducing atmosphere at 600 to 1000° C. or in the air at 500 to 700° C. This allows oxygen to be returned to the partially reduced main phase of the dielectric layers 11 that have been sintered in a reducing atmosphere. It should be noted that the reoxidation treatment step (S10) is implemented in a manner not oxidizing the internal electrode layers 12.

### (11) Plating Treatment Step (S11)

In the plating treatment step (S11), plating treatment is performed on the exposed parts of the first external electrode 20a and second external electrode 20b. Plating treatment is performed using copper (Cu), nickel (Ni), tin (Su), or other metal, for example.

Following the above steps, the multilayer ceramic capacitor 100 can be manufactured.

The aforementioned steps are only an example, and the method for manufacturing the multilayer ceramic capacitor in this embodiment is not limited to the aforementioned mode.

### Other Embodiments

The foregoing described an embodiment in detail, but the present invention/disclosure is not limited to a specific embodiment, and various modifications and changes can be added without departing from the spirit of the present invention/disclosure and equivalents thereof.

For example, while the aforementioned embodiment is applied to a multilayer ceramic capacitor having two terminal electrodes, the present disclosure can also be applied to a multilayer ceramic capacitor having three or more terminals.

Also, while the aforementioned embodiment is explained with respect to a multilayer ceramic capacitor as an example of multilayer ceramic electronic component, the present disclosure can be applied to multilayer ceramic electronic components in general. Such multilayer ceramic electronic components include, for example, chip varistors, chip thermistors, multilayer inductors, and the like.

### [Circuit Module]

The circuit module in this embodiment comprises the multilayer ceramic electronic component in this embodiment. Specific examples of the circuit module include electronic circuit boards on which the multilayer ceramic capacitor 100 is mounted.

On the circuit module, various types of electronic components other than the multilayer ceramic capacitor 100 can also be mounted.

### [Electronic Device]

The electronic device in this embodiment comprises the circuit module in this embodiment. Specific examples of the electronic device include smartphones, tablets, game consoles, electrical components for automobiles, servers, and the like, but they can also include various electronic devices other than the foregoing.

### EXAMPLES

The present disclosure is explained specifically below using examples and comparative examples; however, the present disclosure is not limited to these examples.

### Example 1

A multilayer ceramic capacitor 100 was manufactured according to the flow chart shown in FIG. 8.

### <Raw Material Powder Preparation Step (S1) and Slurry Preparation Step (S2)>

Polyvinyl butyral (PVB) resin as an organic binder, ethanol, toluene, dioctyl phthalate (DOP) as a plasticizer, and silicon dioxide (SiO₂) as a sintering auxiliary agent, were added to and wet-mixed with a powder of barium titanate, to prepare a slurry.

### <Coating Step (S3)>

On polyethylene terephthalate (PET) films, the obtained slurry was coated using a die-coater to produce dielectric layer precursor sheets.

### <Internal Electrode Layer Pattern-Forming Step (S4)>

Copper oxide dispersed in terpineol was added to a mixture of a nickel powder as the main component, a powder of barium titanate as a co-existent material, and polyvinyl butyral resin as an organic binder, in such a way that the additive amount of copper became 1.1 at % based on the additive amount of nickel being 100 at %, to prepare a first metal paste. On the dielectric layer precursor sheets, the first metal paste was printed by means of screen printing, thereby forming internal electrode layer patterns to be extracted alternately to a pair of external electrodes, to form lamination units. These lamination units each had a dielectric layer precursor sheet and an internal electrode layer pattern formed on the surface of the dielectric layer precursor sheet.

### <Laminated Body-Forming Step (S5)>

400 lamination units were laminated while releasing the PET films from the dielectric layer precursor sheets, to form a laminate. Additionally, five cover layers were laminated on the upper face and lower face of the laminate of lamination units, followed by pressure bonding under heat, to form a laminated body. The cover layers had the same compositional makeup as the dielectric layer precursor sheets.

### <Singulation Step (S6)>

The laminated body was singulated to 1.0 mm in length, 0.5 mm in width, and 0.5 mm in height through a singulating process, to obtain chip-shaped laminated bodies (hereinafter also referred to as “precursors to ceramic laminated bodies”).

### <External Electrode-Forming Step (S7)>

A second metal paste containing nickel powder and co-existent material was applied on the first side face 10a and second side face 10b, which are two opposing faces, of each precursor to ceramic laminated body, to form precursors to external electrodes. The precursors to external electrodes were heated at 150° C. for 10 minutes in a nitrogen atmosphere, to dry the solvent in the precursors to external electrode.

### <First Heating Step (S8)>

The precursor to ceramic laminated body was sintered for 5 minutes at 950° C. in a reducing atmosphere of 10⁻⁷ atm in oxygen partial pressure.

### <Second Heating Step (S9)>

The first heating step (S8) was followed by 15 minutes of sintering at 1300° C. in a reducing atmosphere of 10⁻⁹ atm in oxygen partial pressure.

### <Reoxidation Treatment Step (S10)>

The second heating step (S9) was followed by reoxidation treatment at 1000° C. in a nitrogen gas atmosphere.

Based on the above, a multilayer ceramic capacitor 100, which is shaped like a chip of 1.0 mm in length, 0.5 mm in width, and 0.5 mm in height, has a first external electrode 20a and a second external electrode 20b, features an average dielectric layer 11 thickness of 0.4 μm and an average internal electrode layer 12 thickness of 0.6 μm, and comprises 400 laminated layers, was produced.

### Examples 2 to 4 and Comparative Examples 1 and 2

The multilayer ceramic capacitors in Examples 2 to 4 and Comparative Examples 1 and 2 were produced in the same manner as in Example 1, except that, in the internal electrode layer pattern-forming step in Example 1, the additive amount of copper oxide in the first metal paste was changed so that the additive amount of copper became as shown in Table 1 below based on the additive amount of nickel being 100 at %.

### Comparative Example 3

The multilayer ceramic capacitor in Comparative Example 3 was produced in the same manner as in Example 1, except that the first heating step (S8) in Example 1 was not implemented and that the second heating step (S9) was implemented following the external electrode formation step (S7).

### Comparative Example 4

The multilayer ceramic capacitor in Comparative Example 4 was produced in the same manner as in Example 1, except that, in the internal electrode layer pattern-forming step (S4) in Example 1, the first metal paste was changed to a comparative metal paste which was prepared as below.

The comparative metal paste was prepared by adding gold dispersed in terpineol to a mixture of a nickel powder as the main component, a powder of barium titanate as a co-existent material, and polyvinyl butyral resin as an organic binder, in such a way that the additive amount of gold became 1.0 at % based on the additive amount of nickel being 100 at %.

### [Evaluation]

### —Production of Measurement Samples—

Each of the multilayer ceramic capacitors 100 in Examples 1 to 4 and Comparative Examples 1 to 4 was polished along the Y-axis to produce a measurement sample 1 that has been polished down to the center along the Y-axis to expose an XZ-plane in which the dielectric layers 11 and internal electrode layers 12 were laminated.

Next, a region of 0.5 μm×2 μm was cut out from an arbitrary region selected from inside the capacitive part 14 using a focused ion beam (FIB) device (manufactured by Thermo Fisher Scientific Inc.), to produce a measurement sample 2.

### <Checking for Presence/Absence of First Segregation Part 50>

The interface between the first phase 17 and a particle of the co-existent material 18 in an internal electrode layer 12 in the XZ-plane of the measurement sample 2 was measured using a STEM in the direction from the first phase 17 side to the co-existent material 18 side, in the internal electrode layer 12, as indicated by the arrow in FIG. 6B, to perform an element analysis and check if Cu is concentrated at the interface, where it was determined that a first segregation part was “present” when concentration was observed and that a first segregation part was “absent” when no concentration was observed.

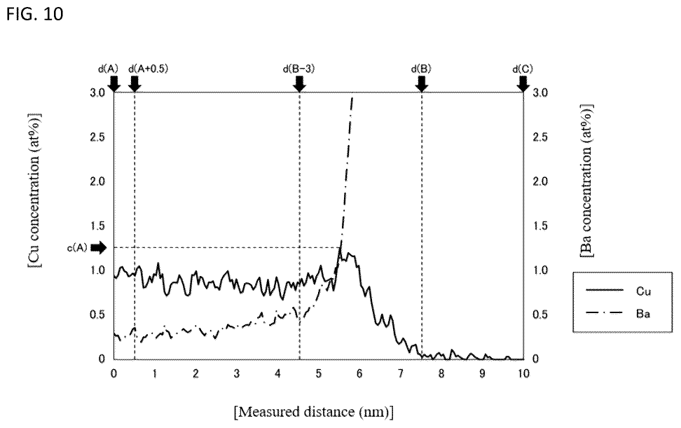

A thin slice of approx. 100 nm in thickness was cut out from the interface between the first phase 17 and a particles of the co-existent material 18 in an internal electrode layer 12 in the XZ-plane of the measurement sample 2, and measured using a STEM in the direction from the first phase 17 side to the co-existent material 18 side, in the internal electrode layer 12, as indicated by the arrow in FIG. 6B, to perform a STEM-based element analysis, and by using the obtained profile data of copper as measured in the direction from the first phase 17 side to the co-existent material 18 side, in the internal electrode layer 12, presence/absence of Cu segregation was evaluated. As an example of the result of the element analysis, the analysis result in Example 1 is shown in FIG. 10.

When the position of the end part at which the measurement on the first phase 17 side in the internal electrode layer 12 was started is given by “position A,” and the distance from position A to an arbitrary position x is indicated by “measured distance d(x) nm,” the measured distance of position A is indicated by “d(A) nm”=0 nm. The measured distance from position A to position B at which the Cu concentration dropped to baseline B is indicated by “d(B) nm.” Next, when the position being the end part at which the measurement in FIG. 10 was terminated is given by “position C,” its measured distance is indicated by “d(C) nm.” The average value of Cu concentration in the co-existent material 18 in the internal electrode layer 12 was defined as the Cu concentration at baseline B. To be specific, the average value of Cu concentration in the range from position B to position C in FIG. 10, or specifically range from measured distance d(B) nm to measured distance d(C) nm, was defined as the Cu concentration at baseline B. From this, the average value of Cu concentration in the first phase 17, not the co-existent material 18, in the internal electrode layer 12 was obtained. Next, based on the position achieved by moving position B by 3 nm to the position A side as “position (B-3),” the peak Cu concentration c(A) in the range from position (B-3) to position B, or specifically range from d(B-3) nm to d(B) nm, was measured. Assuming that the Cu concentration at baseline B was 100 at %, the peak Cu concentration c(A) was measured, and from this, the peak Cu concentration in the first segregation part 50 was obtained. Assuming that the Cu concentration at baseline B was 100 at % and the peak Cu concentration c(A) was 120% or higher, it was determined that a first segregation part 50 where copper being a metal added in the internal electrode layer 12 had segregated was “present” at the interface between the first phase 17 and co-existent material 18. The result is shown in Table 1.

In Comparative Example 4, in which gold was added in place of copper and therefore first segregation parts containing copper were absent, an analysis of the comparative metal Au performed concurrently with the analysis of Cu did not reveal any segregation part where Au had segregated at the interface between the first phase 17 and co-existent material 18.

### <Checking for Presence/Absence of Second Segregation Part 40>

The interface between a dielectric layer 11 and an internal electrode layer 12 in the XZ-plane of the measurement sample 2 was measured using a STEM in the direction from the first phase 17 side in the internal electrode layer 12 to the dielectric layer 11 side, as indicated by the arrow in FIG. 7B, to perform an element analysis and check if Cu is concentrated at the interface, where it was determined that a second segregation part was “present” when concentration was observed and that a second segregation part was “absent” when no concentration was observed.

A thin slice of approx. 100 nm in thickness was cut out from the interface between the first phase 17 in the internal electrode layer 12 and the dielectric layer 11, in the XZ-plane of the measurement sample 2, and measured using a STEM in the direction from the first phase 17 side in the internal electrode layer 12 to the dielectric layer 11 side, as indicated by the arrow in FIG. 7B, to perform a STEM element analysis, and by using the obtained profile data of copper as measured in the direction from the first phase 17 side in the internal electrode layer 12 to the dielectric layer 11 side, presence/absence of Cu segregation was evaluated.

When the position of the end part at which the measurement on the first phase 17 side in the internal electrode layer 12 was started is given by “position D,” and the distance from position D to an arbitrary position x is indicated by “measured distance d(x) nm,” the measured distance of position D is indicated by “d(D) nm”=0 nm. The measured distance from position D to position E at which the Cu concentration dropped to baseline E is indicated by “d(E) nm.” The average value of Cu concentration in the dielectric layer 11 was defined as the Cu concentration at baseline E. To be specific, the average value of Cu concentration in the range from position E to position F, or specifically from measured distance d(E) nm to measured distance d(F) nm, was defined as the Cu concentration at baseline E. This way, the average value of Cu concentration in the dielectric layer 11 was obtained. Next, based on the position achieved by moving position E by 3 nm to the position D side as “position (E-3),” the peak Cu concentration c(B) in the range from position (E-3) to position E, or specifically range from d(E-3) nm to d(E) nm, was measured. Assuming that the Cu concentration at baseline E was 100% and the peak Cu concentration c(B) was 120% or higher, it was determined that a second segregation part 40 where copper being a metal added in the internal electrode layer 12 had segregated was “present” at the interface between the dielectric layer 11 and internal electrode layer 12. The result is shown in Table 2.

In Comparative Example 4, in which gold was added as a comparative metal in place of copper and therefore second segregation parts containing copper were absent, an analysis of the comparative metal Au performed concurrently with the analysis of Cu revealed a segregation part containing gold at the interface between the dielectric layer 11 and internal electrode layer 12, which is indicated in Table 2.

### <Area Ratio of Co-Existent Material 18 in Internal Electrode Layer 12>

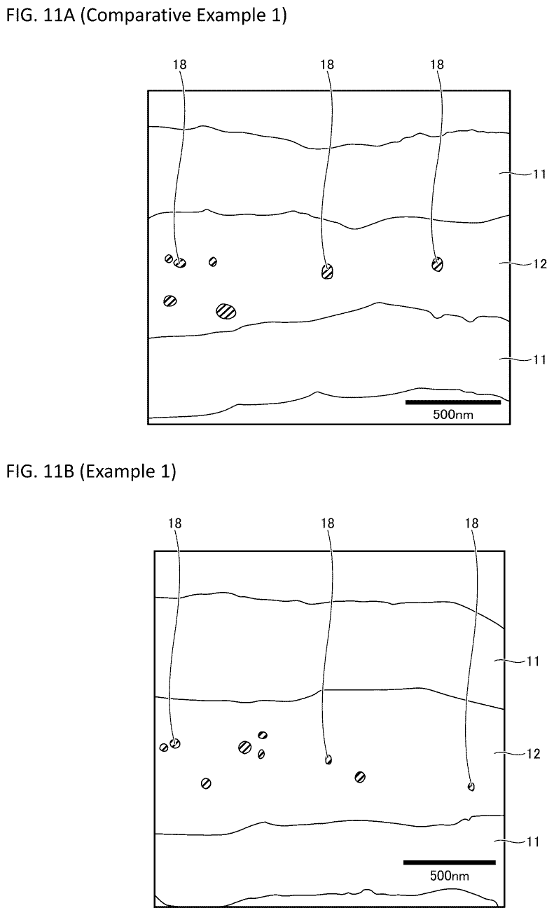

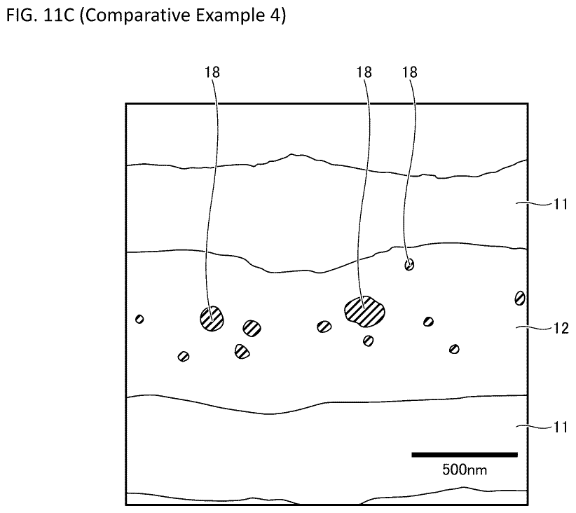

An internal electrode layer 12 in the XZ-plane of the measurement sample 2 in each of Example 1 and Comparative Examples 1 and 4 was observed using a BF-STEM (bright field scanning transmission electron microscope) at a magnification of ×80000. FIG. 11A is a traced drawing of a BF-STEM image taken on the XZ-plane of the measurement sample 2 in Comparative Example 1. FIG. 11B is a traced drawing of a BF-STEM image taken on the XZ-plane of the measurement sample 2 in Example 1. FIG. 11C is a traced drawing of a BF-STEM image taken on the XZ-plane of the measurement sample 2 in Comparative Example 4. Compared to FIGS. 11A (Comparative Example 1) and 11B (Example 1), FIG. 11C (Comparative Example 4) clearly shows the existence of large particles of the co-existent material.

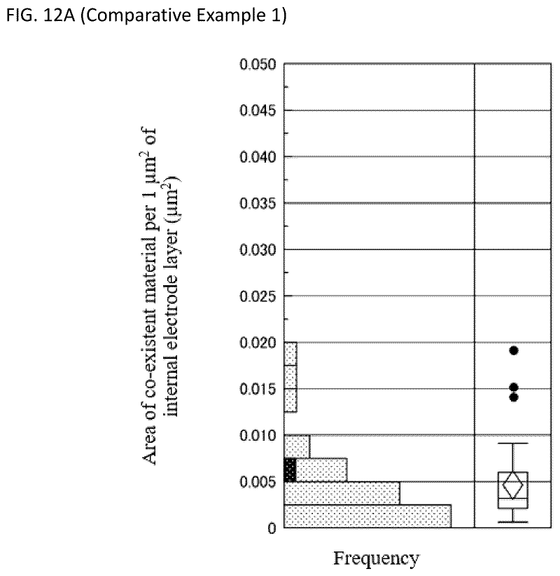

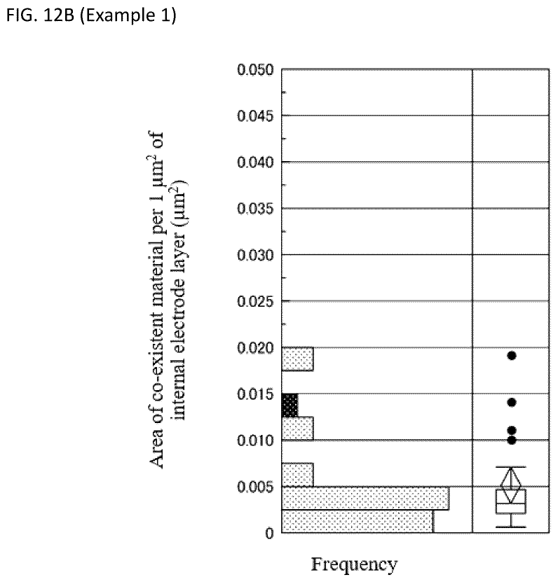

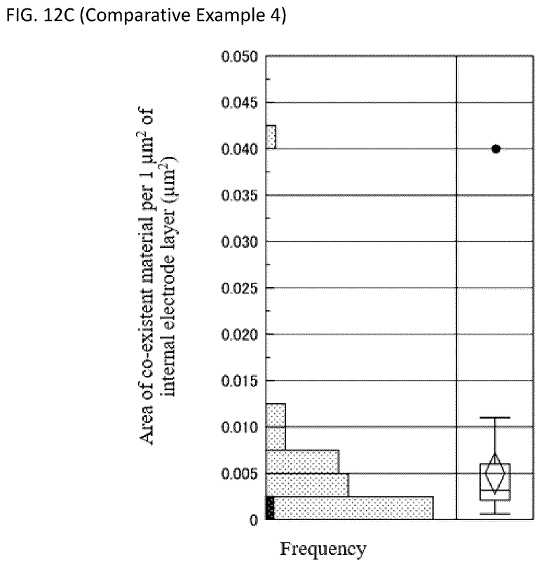

Also, FIG. 12A is a graph showing the frequency of the total area of the co-existent material 18 in three layers, obtained from a BF-STEM image of internal electrode layers 12 on the XZ-plane of the measurement sample 2 in Comparative Example 1. FIG. 12B is a graph showing the frequency of the total area of the co-existent material 18 in three layers, obtained from a BF-STEM image of internal electrode layers 12 on the XZ-plane of the measurement sample 2 in Example 1. FIG. 12C is a graph showing the frequency of the total area of the co-existent material 18 in three layers, obtained from a BF-STEM image of internal electrode layers 12 on the XZ-plane of the measurement sample 2 in Comparative Example 4. It was confirmed with the BF-STEM that, in terms of the total area of the co-existent material 18 not heretofore understood clearly, the smallest particles of the co-existent material 18 are present in a large number in FIG. 12B (Example 1), followed by FIG. 12A (Comparative Example 1), and by FIG. 12C (Comparative Example 4) where large particles of one-digit size are present as outliers.

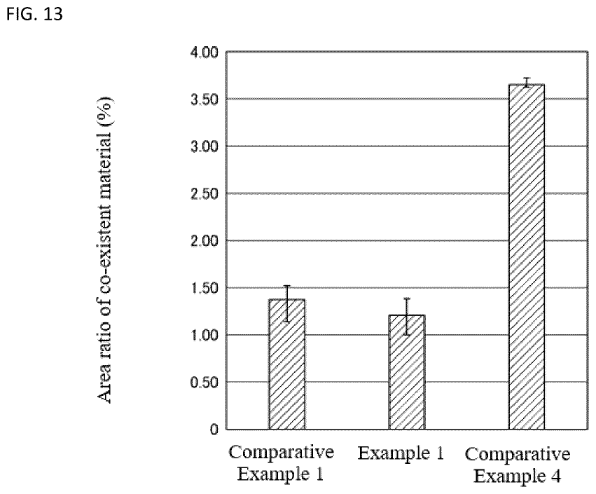

From the BF-STEM image of internal electrode layers 12 taken on the cross-section in the direction of the first axis, which is also the XZ-plane, of the measurement sample 2 in each of Example 1 and Comparative Examples 1 and 4, the overall area of the three internal electrode layers 12, and total area of the co-existent material 18, were obtained, and based on the formula below, the area ratio of co-existent material in the internal electrode layers 12 was obtained. The result is shown in FIG. 13.

Area ratio of co-existent material (%)=Total area of co-existent material 18/Overall area of internal electrode layers 12×100

It was confirmed that the residual co-existent material 18 in the internal electrode layers 12 whose main component is Ni was the least prevalent in Example 1 where Cu was added, the second least prevalent in Comparative Example 1 where copper was not added, and the most prevalent in Comparative Example 4 where Au was added. The results in FIGS. 11A to 13 confirm that adding Cu together with the co-existent material 18 to the internal electrode layers 12 makes it easy to expel the co-existent material 18 to the outside of the internal electrode layers 12. The metal to be added to the internal electrode layers 12 cannot be anything, and there are metals, such as Au, that, when added, make expelling of the co-existent material 18 to the outside of the internal electrode layers 12 difficult instead. While the detailed mechanism of why Cu makes expelling of the co-existent material 18 easy while Au makes expelling of the co-existent material 18 difficult is not clear, it is considered that, because Au is added as a single substance of Au but Cu is added in the form of an oxide such as CuO, the desorption of oxygen atoms (O) at the time of sintering may have facilitated flow.

### <Diffusibility of Metals to Dielectric Layers 11>

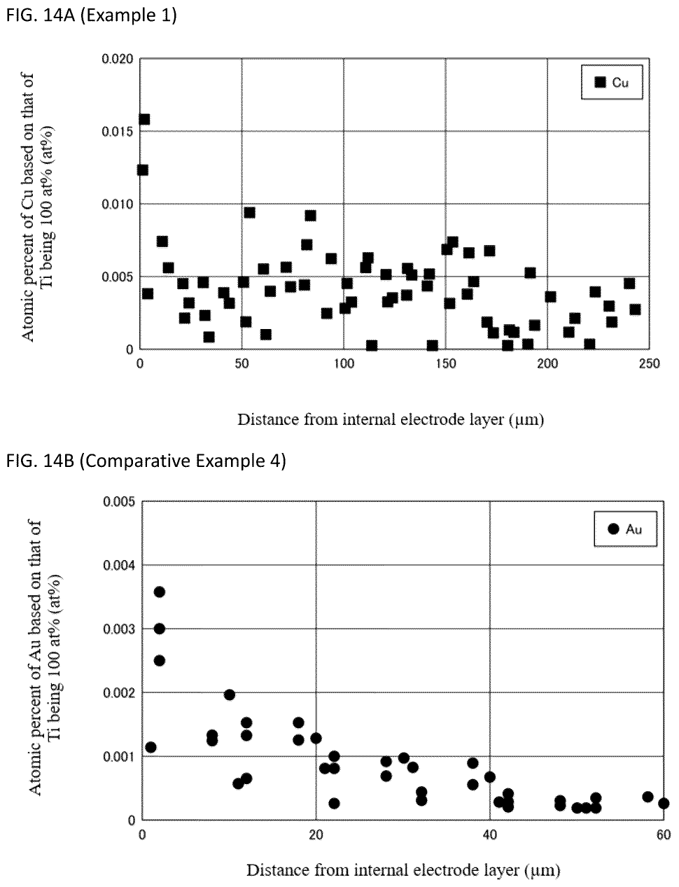

The dielectric layers 11 of the multilayer ceramic capacitors 100 in Example 1 and Comparative Example 4 were scanned under the following conditions using a laser ablation inductively coupled plasma mass spectrometer (LA-ICP-MS), to perform an element analysis on Cu and Au. The laser irradiation diameter was set to 3 μm, the scanning mode, to spot irradiation, and the frequency, to 10 Hz. The laser irradiation pattern was set to continuous point analysis. According to the semiquantitative analysis method using a glass standard reference material, the atomic percent (at %) of Cu or Au was calculated based on that of Ti being 100 at %. FIG. 14A is a graph showing the result, in Example 1, of the atomic percent of Cu (at %) based on that of Ti being 100 at % according to the semiquantitative analysis method using a glass standard reference material. FIG. 14B is a graph showing the result, in Comparative Example 4, of the atomic percent of Au (at %) based on that of Ti being 100 at % according to the semiquantitative analysis using a glass standard reference material.

FIGS. 14A and 14B show that adding Cu to the internal electrode layers 12 caused more Cu to diffuse in the dielectric layers 11 compared to adding Au to the internal electrode layers 12. From this, the result in FIG. 14B is considered to indicate that adding Au to the internal electrode layers 12 caused the co-existent material 18 to remain in large amounts in the internal electrode layers 12 due to small amounts of Au diffusing, while adding Cu to the internal electrode layers 12 caused the co-existent material 18 to remain in small amounts in the internal electrode layers 12 due to large amounts of Cu diffusing.

### <Connectivity>

The XZ-planes of the measurement samples 1 were observed with a SEM. Using as a control the multilayer ceramic capacitor 100 in Comparative Example 1 whose internal electrode layers 12 were constituted by Ni alone with neither Cu nor Au added thereto, the state of connection between the internal electrode layers 12 and external electrodes 20 was checked in a total of 60 locations including 20 locations selected arbitrarily from each of the top edge part, center part, and bottom edge part in the Z-axis direction, from the XZ-plane of each measurement sample 1. It should be noted that the “state of connection” here indicates the state of how the internal electrode layers 12 and external electrodes 20 are connected on a SEM image of the XZ-plane of the measurement sample 1. To be specific, two situations were determined as indicative of good connectivity, including a situation where the internal electrode layers 12 and external electrodes 20 were observed without any boundaries in between on the SEM image, and a situation where the internal electrode layers 12 and external electrodes 20 were only contacting on the SEM image with their boundary parts visible but 80% or more of the internal electrode layers 12 in the thickness direction were making contact, in each of the observed locations. Two situations were determined as indicative of poor connectivity, including a situation where the internal electrode layers 12 and external electrodes 20 were only contacting on the SEM image with their boundary parts visible and less than 80% of the internal electrode layers 12 in the thickness direction were making contact, and a situation where the internal electrode layers 12 and external electrodes 20 were not contacting on the SEM image with voids visible between the internal electrode layers 12 and external electrodes 20. The connectivity of the measurement sample was evaluated based on the evaluation criteria below, by calculating the percentage of the number of locations with a good state of connection among the 60 locations measured in each of Examples 1 to 4 and Comparative Examples 2 to 4, to the number of locations with a good state of connection among the 60 locations measured on the control (Comparative Example 1). It should be noted that Comparative Example 1, which was used as a control in the evaluation of connectivity, was given a “C.” The results are shown in Table 3.

### —Evaluation Criteria—

A: It can be confirmed that the state of connection is better than that of the control (Comparative Example 1) by 10% or more.

B: The state of connection is better than that of the control (Comparative Example 1) by 2% or more but no more than 10%.

C: The state of connection is better than that of the control (Comparative Example 1) by less than 2%, or equivalent to or worse than Comparative Example 1.

### <Reliability>

A 6-V, 125° C. highly accelerated service life test (HALT) was conducted to evaluate the reliability. For the HALT service life, the average value of service life of 100 samples was calculated for each of the multilayer ceramic capacitors 100 in Examples 1 to 4 and Comparative Examples 1 to 4. An evaluation was made based on the evaluation criteria below, by using as a control the multilayer ceramic capacitor 100 in Comparative Example 1 whose internal electrode layers 12 were constituted by Ni alone with neither Cu nor Au added thereto. It should be noted that Comparative Example 1, which was used as a control in the evaluation of reliability, was given a “C.” The results are shown in Table 3.

### —Evaluation Criteria—

A: The average value of service life is twice that of the control (Comparative Example 1) or longer.

B: The average value of service life is 1.5 times that of the control (Comparative Example 1) or longer.

C: The average value of service life is equal to or shorter than 1.5 times that of the control (Comparative Example 1).

### <Overall Evaluation>

From the evaluation results of connectivity and reliability, an overall evaluation was made based on the evaluation criteria below. An overall evaluation of “A” or “B” indicates practical utility, where “A” is considered particularly good. It should be noted that Comparative Example 1, which was used as a control in the evaluation of connectivity and reliability, was given a “D.” The results are shown in Table 3.

### —Evaluation Criteria—

A: The connectivity is “A” and reliability is “A.”

B: One of the connectivity and reliability is “A” and the other is “B.”

B: One of the connectivity and reliability is “A” or “B” and the other is “C.”

D: Both the connectivity and reliability are “C.”

TABLE 1

| | | | | First phase-co-existent material interface | | | |
|---|---|---|---|---|---|---|---|
| | Additive amount of additive | | | Average | | | |
| | metal | | | value of Cu | | | |
| | Concentration | | | concentration | | Peak Cu | c(A)/ |
| | of Cu | Concentration | First | in first phase | Presence/absence | concentration | B × |
| | relative to | of Au relative | heating | (baseline) B | of first | c(A) | 100 |
| | Ni [at %] | to Ni [at %] | step | [at %] | segregation part | [at %] | [%] |
| Comparative | 0.0 | 0.0 | Yes | — | — | — | — |
| Example 1 | | | | | | | |
| Comparative | 0.6 | 0.0 | Yes | 0.5 | Absent | 0.58 | 116 |
| Example 2 | | | | | | | |
| Example 1 | 1.1 | 0.0 | Yes | 1.0 | Present | 1.25 | 125 |
| Example 2 | 3.1 | 0.0 | Yes | 3.2 | Present | 4.20 | 131 |
| Example 3 | 5.6 | 0.0 | Yes | 5.5 | Present | 8.59 | 156 |
| Example 4 | 11.0 | 0.0 | Yes | 10.5 | Present | 15.00 | 143 |
| Comparative | 1.2 | 0.0 | No | 1.3 | Absent | 1.45 | 112 |
| Example 3 | | | | | | | |
| Comparative | 0.0 | 1.0 | Yes | — | Absent (*Au | — | — |
| Example 4 | | | | | segregation: | | |
| | | | | | Absent) | | |

TABLE 2

| | | | | Internal electrode layer (first phase)-dielectric layer | | | |
|---|---|---|---|---|---|---|---|
| | | | | interface | | | |
| | | | | Average | | | |
| | Additive amount of additive | | | value of Cu | | | |
| | metal | | | concentration | | | |
| | Concentration | | | in dielectric | | Peak Cu | c(B)/ |
| | of Cu | Concentration | First | layer | Presence/absence | concentration | E × |
| | relative to | of Au relative | heating | (baseline) E | of second | c(B) | 100 |
| | Ni [at %] | to Ni [at %] | step | [at %] | segregation part | [at %] | [%] |
| Comparative | 0.0 | 0.0 | Yes | — | — | — | — |
| Example 1 | | | | | | | |
| Comparative | 0.6 | 0.0 | Yes | 0.5 | Present | 0.59 | 118 |
| Example 2 | | | | | | | |
| Example 1 | 1.1 | 0.0 | Yes | 1.0 | Present | 1.25 | 125 |
| Example 2 | 3.1 | 0.0 | Yes | 3.2 | Present | 4.40 | 138 |
| Example 3 | 5.6 | 0.0 | Yes | 5.5 | Present | 8.60 | 156 |
| Example 4 | 11.0 | 0.0 | Yes | 10.5 | Present | 14.80 | 141 |
| Comparative | 1.2 | 0.0 | No | 1.3 | Absent | 1.39 | 107 |
| Example 3 | | | | | | | |
| Comparative | 0.0 | 1.0 | Yes | — | Absent (*Au | — | — |
| Example 4 | | | | | segregation: | | |
| | | | | | Present) | | |

TABLE 3

| | Connectivity | Reliability | Overall evaluation |
|---|---|---|---|
| Comparative | C | C | D |
| Example 1 | | | |
| Comparative | C | C | D |
| Example 2 | | | |
| Example 1 | A | B | B |
| Example 2 | A | A | A |
| Example 3 | A | A | A |
| Example 4 | B | A | B |
| Comparative | C | C | D |
| Example 3 | | | |
| Comparative | C | A | C |
| Example 4 | | | |

Examples 1 to 4 confirmed that the content of copper (concentration of copper relative to nickel) in the first phase 17 in the internal electrode layers 12 is preferably 1 at % or higher but no higher than 11 at %, or more preferably 1 at % or higher but no higher than 6 at %, from the viewpoint of connectivity.

Examples 1 to 4 confirmed that the content of copper (concentration of copper relative to nickel) in the first phase 17 in the internal electrode layers 12 is preferably 1 at % or higher, or more preferably 3 at % or higher, from the viewpoint of reliability.

Examples 1 to 4 confirmed that the content of copper (concentration of copper relative to nickel) in the first phase 17 in the internal electrode layers 12 is preferably 1 at % or higher but no higher than 11 at % overall. It was confirmed that 3 at % or higher but no higher than 6 at % is particularly preferred from the overall viewpoint of connectivity between the internal electrode layers 12 and external electrodes 20 as well as reliability.

It was confirmed that first segregation parts 50 cannot be formed if the content of copper (concentration of copper relative to nickel) in the first phase 17 is too low, as is the case of Comparative Example 2. It was confirmed that Cu cannot be segregated at the interfaces between the first phase 17 and particles of the co-existent material 18 and consequently first segregation parts 50 cannot be formed if the first heating step is not implemented, even though the content of copper (concentration of copper relative to nickel) in the first phase 17 is higher than in Example 1, as is the case of Comparative Example 3. It is considered that, in both Comparative Examples 2 and 3, non-formation of first segregation parts 50 prevented the co-existent material 18 from being expelled by the flows of copper inside the internal electrode layers 12 at the time of sintering, while an insufficient level of the amount of copper heading toward the external electrodes 20 prevented an improvement in the connectivity between the internal electrode layers 12 and external electrodes 20, and the reliability did not improve, either, because the co-existent material 18 remained in the internal electrode layers 12.

The above results show that the multilayer ceramic capacitors 100 conforming to the present disclosure were able to inhibit an over-sintering of the internal electrode layers 12, improve the connectivity between the internal electrode layers 12 and external electrodes 20, and also improve the reliability because small amounts of the co-existent material 18 remained in the internal electrode layers 12 after sintering.

Modes of the present disclosure include the following, for example.
<1> A multilayer ceramic electronic component, comprising: an element body having multiple dielectric layers laminated along a first axis and multiple internal electrode layers respectively placed along the first axis between the adjacent pairs of the dielectric layers; and a pair of external electrodes provided on the surfaces of the element body and electrically connected to the internal electrode layers; wherein, the dielectric layers contain a compound expressed by the general formula ABO_{3-α} (0≤α≤1) and having a perovskite structure; the internal electrode layers contain a first phase containing nickel and copper, as well as a co-existent material, and have, at the interfaces between the first phase and particles of the co-existent material, first segregation parts where copper has segregated; the concentration of copper in the first segregation parts is higher than the concentration of copper in the first phase; and the external electrodes contain nickel.
<2> The multilayer ceramic electronic component according to <1> above, wherein the concentration of copper in the first segregation parts relative to the concentration of copper in the first phase is 120% or higher.
<3> The multilayer ceramic electronic component according to <1> or <2> above, wherein the peak concentration of copper in the first segregation part is 1.20 at % or higher.
<4> The multilayer ceramic electronic component according to any one of <1> to <3> above, wherein, in a cross-section of the element body in the direction of the first axis, the cross-section area of the co-existent material relative to the cross-section area of the internal electrode layers is 1.5% or less.
<5> The multilayer ceramic electronic component according to any one of <1> to <4> above, having, at the interfaces between the dielectric layers and corresponding internal electrode layers, second segregation parts where copper has segregated.
<6> The multilayer ceramic electronic component according to any one of <1> to <5> above, wherein the external electrodes contain copper.
<7> The multilayer ceramic electronic component according to any one of <1> to <6> above, wherein the external electrodes contain a co-existent material.
<8> A method for manufacturing multilayer ceramic electronic component, including: an internal electrode layer pattern-forming step to form internal electrode layer patterns, using a first metal paste containing nickel, copper oxide, and co-existent material, on dielectric layer precursor sheets containing a raw material powder for ceramic that contains a compound expressed by the general formula ABO_{3-α} (0≤α≤1) and having a perovskite structure; a laminated body-forming step to form a laminated body in which multiple layers of the dielectric layer precursor sheets on which the internal electrode layer patterns have been formed are laminated along the first axis in such a way that the internal electrode layer patterns are exposed alternately to two opposing end faces; an external electrode precursor-forming step to form precursors to external electrodes on the surface of the laminated body using a second metal paste containing nickel; a first heating step to heat at 800° C. or higher but no higher than 1000° C. the laminated body on which the precursors to external electrodes have been formed; and a second heating step to heat, following the first heating step, the laminated body on which the precursors to external electrodes have been formed so that dielectric layers will be formed from the dielectric layer precursor sheets, internal electrode layers will be formed from the internal electrode layer patterns, external electrodes will be formed from the precursors to external electrodes, first segregation parts where copper has segregated will be formed at the interfaces between the first phase and particles of the co-existent material in the internal electrode layers that contain the first phase containing nickel and copper and the co-existent material, and the concentration of copper in the first segregation parts will become higher than the concentration of copper in the first phase.
<9> The method for manufacturing multilayer ceramic electronic component according to <8> above, wherein the first metal paste contains the copper oxide in such a way that the concentration of copper relative to the concentration of the nickel becomes 1 at % or higher but no higher than 11 at %.
<10> A circuit module comprising the multilayer ceramic electronic component according to any one of <1> to <7> above.
<11> An electronic device having the circuit module according to <10> above.

The foregoing explained the present disclosure based on a specific embodiment and examples; however, these embodiment and examples are presented only as an example and the present disclosure is not limited by the aforementioned embodiment and examples. The aforementioned embodiment can be implemented in various other modes, and can accommodate various types of combinations, exclusions, substitutions, additions, change, and the like, to the extent that doing so does not deviate from the key points of the invention. These embodiments and modifications thereof are included in the scope and key points of the invention and also included in the scope without departing from the spirit of the present invention/disclosure and equivalents thereof.

In this disclosure, in some embodiments, the material/composition constituting dielectric layers, internal electrode layers, side margins, end margins, first and second segregation parts, co-existent material, and perovskite structures may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality by atomic percentage or by mass depending on the component at issue, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”) may refer to precise values or approximate/rounded values and include equivalents, and may refer to average, median, representative, majority, etc. in some embodiments. In this disclosure, “a” may refer to a species or a genus including multiple species, while a plural may not exclude singular according to the context. Further, “the disclosure” or “the present disclosure” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, in the present disclosure where conditions and/or structures are not specified, a skilled artisan in the art can readily provide such conditions and/or structures, in view of the present disclosure, as a matter of routine experimentation, etc.

What is claimed:

1. A multilayer ceramic electronic component, comprising:
an element body having multiple dielectric layers laminated along a first axis and multiple internal electrode layers respectively placed along the first axis between adjacent pairs of the dielectric layers; and
a pair of external electrodes provided on surfaces of the element body and electrically connected to the internal electrode layers;
wherein,
the dielectric layers contain a compound expressed by a general formula ABO_{3-α} (0≤α≤1) and having a perovskite structure wherein A and B represent an A-site element and a B-site element, respectively, of the perovskite structure;
the internal electrode layers contain a first phase containing nickel and copper, as well as a co-existent material, and have, at interfaces between the first phase and particles of the co-existent material, first segregation parts where copper has segregated;
a concentration of copper in the first segregation parts is higher than a concentration of copper in the first phase; and
the external electrodes contain nickel.

2. The multilayer ceramic electronic component according to claim 1, wherein the concentration of copper in the first segregation parts relative to the concentration of copper in the first phase is 120% or higher.

3. The multilayer ceramic electronic component according to claim 1, wherein a peak concentration of copper in the first segregation part is 1.20 at % or higher.

4. The multilayer ceramic electronic component according to claim 1, wherein, in a cross-section of the element body in a direction of the first axis, a cross-section area of the co-existent material relative to a cross-section area of the internal electrode layers is 1.5% or less.

5. The multilayer ceramic electronic component according to claim 1, having, at interfaces between the dielectric layers and corresponding internal electrode layers, second segregation parts where copper has segregated.

6. The multilayer ceramic electronic component according to claim 1, wherein the external electrodes contain copper.

7. The multilayer ceramic electronic component according to claim 1, wherein the external electrodes contain a co-existent material.

8. A method for manufacturing multilayer ceramic electronic component, including:
an internal electrode layer pattern-forming step to form internal electrode layer patterns, using a first metal paste containing nickel, copper oxide, and co-existent material, on dielectric layer precursor sheets containing a raw material powder for ceramic that contains a compound expressed by a general formula ABO_{3-α} (0≤α≤1) and having a perovskite structure wherein A and B represent an A-site element and a B-site element, respectively, of the perovskite structure;
a laminated body-forming step to form a laminated body in which multiple layers of the dielectric layer precursor sheets on which the internal electrode layer patterns have been formed are laminated along the first axis in such a way that the internal electrode layer patterns are exposed alternately to two opposing end faces;
an external electrode precursor-forming step to form precursors to external electrodes on a surface of the laminated body using a second metal paste containing nickel;
a first heating step to heat at 800° C. or higher but no higher than 1000° C. the laminated body on which the precursors to external electrodes have been formed; and
a second heating step to heat the laminated body on which the precursors to external electrodes have been formed, following the first heating step, so that dielectric layers will be formed from the dielectric layer precursor sheets, internal electrode layers will be formed from the internal electrode layer patterns, external electrodes will be formed from the precursors to external electrodes, first segregation parts where copper has segregated will be formed at interfaces between the first phase and particles of the co-existent material in the internal electrode layers that contain the first phase containing nickel and copper and the co-existent material, and a concentration of copper in the first segregation parts will become higher than a concentration of copper in the first phase.

9. The method for manufacturing multilayer ceramic electronic component according to claim 8, wherein the first metal paste contains the copper oxide in such a way that a concentration of copper relative to a concentration of the nickel becomes 1 at % or higher but no higher than 11 at %.

10. A circuit module comprising the multilayer ceramic electronic component according to claim 1.

11. An electronic device having the circuit module according to claim 10.
